(19) United States
(12) Patent Application Publication
(10) Pub. No.: US 2009/0060542 A1
(43) Pub. Date: Mar. 5, 2009

(54) Image Forming Apparatus and an Image Forming Method

(75) Inventors: Kunihiro KAWADA, Matsumoto-shi (JP); Yujiro NOMURA, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/197,926

(22) Filed: Aug. 25, 2008

(30) Foreign Application Priority Data
Aug. 27, 2007 (JP) 2007-219769
Jul. 9, 2008 (JP) 2008-179398

(51) Int. Cl. G03G 15/00

(52) U.S. Cl. 399/47

(57) ABSTRACT

An image forming apparatus includes: an exposure head including an imaging optical system arranged in a first direction and a light emitting element that emits light to be imaged by the imaging optical system; a latent image bearing member that moves in a second direction and carries a latent image formed by the exposure head; a developing unit that develops the latent image formed by the exposure head; a detector that detects the image developed by the developing unit; and a controller that controls image formation such that a width L1 in the first direction of a latent image formed on the latent image bearing member by one imaging optical system and a width L2 in the first direction of the image detected by the detector has a relationship of L2>L1.

### CROSS REFERENCE TO RELATED APPLICATION

The disclosure of Japanese Patent Applications No. 2007-219769 filed on Aug. 27, 2007 and No. 2008-179398 filed on Jul. 9, 2008 including specification, drawings and claims is incorporated herein by reference in its entirety.

### BACKGROUND

1. Technical Field

The invention relates to an image forming apparatus and an image forming in which a test image is properly detected.

2. Related Art

There has been conventionally known an image forming apparatus for forming a test image and obtaining image formation information relating to image formation by detecting this test image. For example, an image forming apparatus disclosed in Japanese Patent No. 2642351 obtains color misregistration information as image formation information to form a satisfactory color image by properly superimposing a plurality of colors. More specifically, the apparatus disclosed in this literature forms registration marks (“detection pattern” in this literature) as test images for a plurality of colors. The registration marks of the respective colors are detected by optical sensors and then the positions thereof are obtained from this detection result. The color misregistration information can be obtained from the positions of the registration marks of the respective colors thus obtained.

Further; in an image forming apparatus disclosed in JP-A-7-111591 or JP-A-2001-75325, density information is obtained as image formation information to realize a proper image density. More specifically, this apparatus forms a patch mark (“patch image” disclosed in JP-A-2001-75325) as a test image under a specified condition and detects this patch mark using an optical sensor. The density information is obtained based on the density of the patch mark obtained from the detection result of the optical sensor.

### SUMMARY

For the realization of high-resolution image formation, a surface of a latent image bearing member may be exposed by the following line head. This line head includes a plurality of light emitting elements grouped into light emitting element groups, and the respective light emitting element groups emit light beams toward the surface of the latent image bearing member moving in a sub scanning direction to expose areas mutually different in a main scanning direction orthogonal to the sub scanning direction. Further, N (N is an integer equal to or greater than 2) light emitting element groups capable of exposing areas consecutive in the main scanning direction are respectively arranged while being displaced in a direction corresponding to the sub scanning direction. In the case of forming a test image, the light emitting element groups expose the surface of the latent image bearing member to form a test latent image and this test latent image is developed to form the test image. However, there are cases where the positions of the formed latent images vary in the sub scanning direction among the N light emitting element groups displaced in the direction corresponding to the sub scanning direction due to a variation of the moving speed of the surface of the latent image bearing member. In other words, there are cases where the positions of the N latent images consecutively formed in the main scanning direction vary in the sub scanning direction. A similar variation occurs also in the test image obtained by developing the test latent image having such a variation. Accordingly, upon detecting the test image, it is preferable to properly detect the test image by reflecting such a variation on the detection result.

An advantage of some aspects of the invention is to provide technology for enabling the proper detection of a test image by reflecting a variation in a sub scanning direction of the positions of N latent images consecutively formed in a main scanning direction on the detection result on the test image.

An apparatus according to an aspect of the invention comprises: an exposure head including an imaging optical system arranged in a first direction and a light emitting element that emits light to be imaged by the imaging optical system; a latent image bearing member that moves in a second direction and carries a latent image formed by the exposure head; a developing unit that develops the latent image formed by the exposure head; a detector that detects the image developed by the developing unit; and a controller that controls image formation such that a width L1 in the first direction of a latent image formed on the latent image bearing member by one imaging optical system and a width L2 in the first direction of the image detected by the detector has a relationship of L2>L1.

A method according to an aspect of the invention comprises: forming a latent image on a latent image bearing member by an exposure head including an imaging optical system arranged in a first direction and a light emitting element for emitting light to be imaged by the imaging optical system, the latent image bearing member moving in a second direction; developing the latent image formed by the exposure head; and detecting the image formed such that a width L1 in the first direction of a latent image formed on the latent image bearing member by one imaging optical system and a width L2 in the first direction of the image detected by the detector has a relationship of L2>L1.

An apparatus according to another aspect of the invention comprises: an exposure head including an imaging optical system arranged in a first direction and a light emitting element that emits light to be imaged by the imaging optical system; a latent image bearing member that moves in a second direction and carries a latent image formed by the exposure head; a developing unit that develops the latent image formed by the exposure head; a detector that detects the image developed by the developing unit; and a controller that controls image formation such that a width L3 in the first direction of a latent image formed on the latent image bearing member by two or more imaging optical systems and a width L2 in the first direction of the image detected by the detector has a relationship of L2>L3.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a diagram showing an embodiment of an image forming apparatus to which the invention is applicable;

FIG. 2 is a diagram showing the electrical construction of the image forming apparatus of FIG. 1;

FIG. 3 is a perspective view schematically showing a line head;

FIG. 4 is a sectional view along a width direction of the line head shown in FIG. 3;

FIG. 5 is a schematic partial perspective view of the lens array;

FIG. 6 is a sectional view of the lens array in the longitudinal direction;

FIG. 7 is a diagram showing the arrangement of the light emitting element groups in the line head;

FIG. 8 is a diagram showing the arrangement of the light emitting elements in each light emitting element group;

FIGS. 9 and 10 are diagrams showing terminology used in this specification;

FIG. 11 is a perspective view showing an exposure operation by the line head;

FIG. 12 is a side view showing the exposure operation by the line head;

FIG. 13 is a diagram showing an example of a latent image forming operation by the line head;

FIG. 14 is a graph showing a relationship between the speed variation of the moving speed of the surface of the photosensitive member and time;

FIG. 15 is a diagram showing positional variations, which can occur in a latent image;

FIG. 16 is a diagram showing a construction for performing the test image detection operation;

FIG. 17 is a diagram showing an example of the optical sensor;

FIG. 18 is a graph of a sensor spot;

FIG. 19 is a diagram showing a first example of the test image detection operation in the embodiment of the invention;

FIG. 20 is a diagram showing a case where a main-scanning spot diameter of the sensor spot is equal to or smaller than the (N-1)-fold of the unit width;

FIG. 21 is a diagram showing a second example of the test image detection operation according to the embodiment of the invention;

FIG. 22 is a diagram showing a third example of the test image detection operation according to the embodiment of the invention;

FIG. 23 is a diagram showing a construction for performing the color misregistration correction operation;

FIG. 24 is a diagram showing a process performed based on the detection result of the optical sensor;

FIG. 25 is a diagram showing an electrical construction for performing the process based on the detection result of the optical sensor;

FIG. 26 is a diagram showing a process performed to the detection result of the optical sensor;

FIG. 27 is a diagram showing the electrical construction for performing the process to the detection result of the optical sensor;

FIG. 28 is a diagram showing a process performed to the detection result of the optical sensor;

FIG. 29 is a diagram showing the electrical construction for performing the process to the detection result of the optical sensor;

FIG. 30 is a diagram showing registration marks formed in a color misregistration correction operation in the main scanning direction;

FIG. 31 is a diagram showing the principle of the color misregistration correction operation in the main scanning direction;

FIG. 32 is graphs showing the color misregistration correction operation in the main scanning direction;

FIG. 33 is a diagram showing a relationship between the sensor spot of the optical sensor and a registration mark in the color misregistration correction operation in the main scanning direction;

FIG. 34 is a diagram showing registration marks formed in a sub scanning magnification displacement correction operation;

FIG. 35 is graphs showing the sub scanning magnification displacement correction operation;

FIG. 36 is a diagram showing a modification of the optical sensor;

FIG. 37 is a diagram showing another configuration of the test latent image;

FIG. 38 is a diagram showing a test image detection operation in the case of N=2; and

FIG. 39 is a diagram showing exemplary sizes of a sensor spot and a registration mark.

### BRIEF DESCRIPTION OF EXEMPLARY EMBODIMENTS

I. Basic Construction of an Image Forming Apparatus

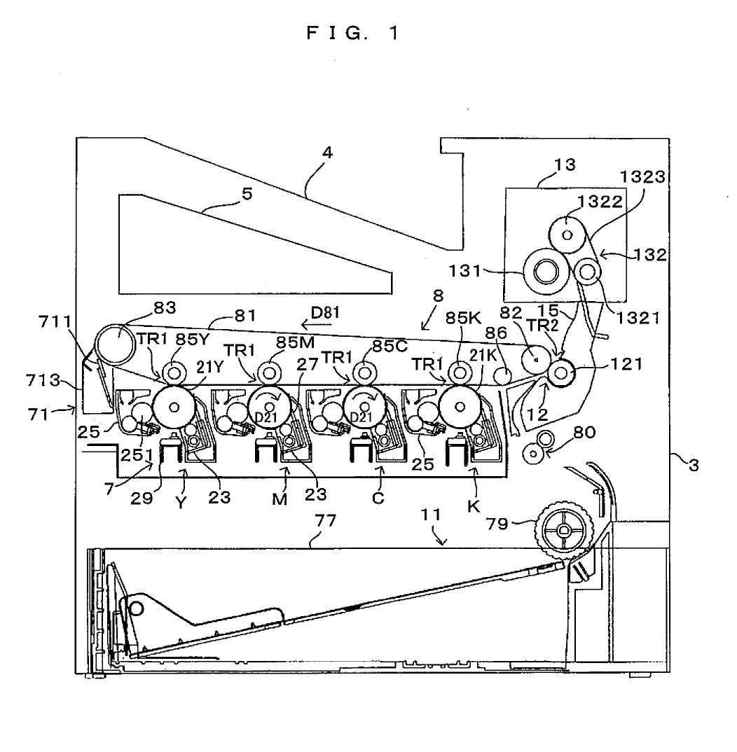

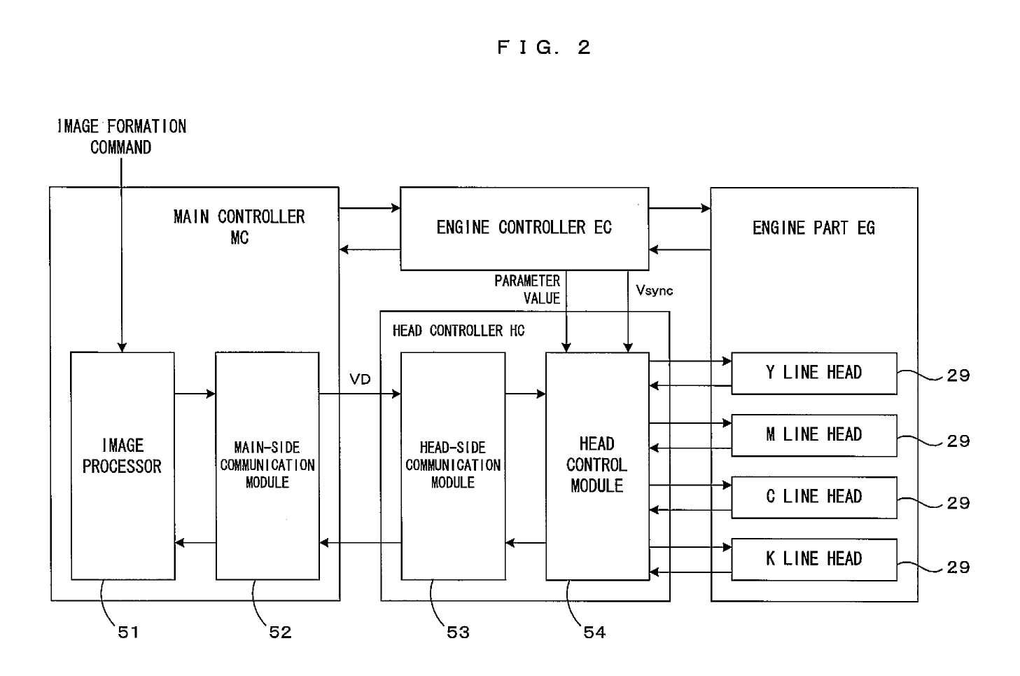

FIG. 1 is a diagram showing an embodiment of an image forming apparatus to which the invention is applicable. FIG. 2 is a diagram showing the electrical construction of the image forming apparatus of FIG. 1. This apparatus is an image forming apparatus that can selectively execute a color mode for forming a color image by superimposing four color toners of black (K), cyan (C), magenta (M) and yellow (Y) and a monochromatic mode for forming a monochromatic image using only black (K) toner. FIG. 1 is a diagram corresponding to the execution of the color mode. In this image forming apparatus, when an image formation command is given from an external apparatus such as a host computer to a main controller MC having a CPU and memories, the main controller MC feeds a control signal and the like to an engine controller EC and feeds video data VD corresponding to the image formation command to a head controller HC. This head controller HC controls line heads 29 of the respective colors based on the video data VD from the main controller MC, a vertical synchronization signal Vsync from the engine controller EC and parameter values from the engine controller EC. In this way, an engine part EG performs a specified image forming operation to form an image corresponding to the image formation command on a sheet such as a copy sheet, transfer sheet, form sheet or transparent sheet for OHP.

An electrical component box 5 having a power supply circuit board, the main controller MC, the engine controller EC and the head controller HC built therein is disposed in a housing main body 3 of the image forming apparatus. An image forming unit 7, a transfer belt unit 8 and a sheet feeding unit 11 are also arranged in the housing main body 3. A secondary transfer unit 12, a fixing unit 13 and a sheet guiding member 15 are arranged at the right side in the housing main body 3 in FIG. 1. It should be noted that the sheet feeding unit 11 is detachably mountable into the housing main body 3. The sheet feeding unit 11 and the transfer belt unit 8 are so constructed as to be detachable for repair or exchange respectively.

The image forming unit 7 includes four image forming stations Y (for yellow), M (for magenta), C (for cyan) and K (for black) which form a plurality of images having different colors. Each of the image forming stations Y, M, C and K includes a cylindrical photosensitive drum 21 having a surface of a specified length in a main scanning direction MD. Each of the image forming stations Y, M, C and K forms a toner image of the corresponding color on the surface of the photosensitive drum 21. The photosensitive drum is arranged so that the axial direction thereof is substantially parallel to the main scanning direction MD. Each photosensitive drum 21 is connected to its own driving motor and is driven to rotate at a specified speed in a direction of arrow D21 in FIG. 1, whereby the surface of the photosensitive drum 21 is transported in a sub scanning direction SD which is orthogonal to or substantially orthogonal to the main scanning direction MD. Further, a charger 23, the line head 29, a developer 25 and a photosensitive drum cleaner 27 are arranged in a rotating direction around each photosensitive drum 21. A charging operation, a latent image forming operation and a toner developing operation are performed by these functional sections. Accordingly, a color image is formed by superimposing toner images formed by all the image forming stations Y, M, C and K on a transfer belt 81 of the transfer belt unit 8 at the time of executing the color mode, and a monochromatic image is formed using only a toner image formed by the image forming station K at the time of executing the monochromatic mode. Meanwhile, since the respective image forming stations of the image forming unit 7 are identically constructed, reference characters are given to only some of the image forming stations while being not given to the other image forming stations in order to facilitate the diagrammatic representation in FIG. 1.

The charger 23 includes a charging roller having the surface thereof made of an elastic rubber. This charging roller is constructed to be rotated by being held in contact with the surface of the photosensitive drum 21 at a charging position. As the photosensitive drum 21 rotates, the charging roller is rotated at the same circumferential speed in a direction driven by the photosensitive drum 21. This charging roller is connected to a charging bias generator (not shown) and charges the surface of the photosensitive drum 21 at the charging position where the charger 23 and the photosensitive drum 21 are in contact upon receiving the supply of a charging bias from the charging bias generator.

The line head 29 is arranged relative to the photosensitive drum 21 so that the longitudinal direction thereof corresponds to the main scanning direction MD and the width direction thereof corresponds to the sub scanning direction SD. Hence, the longitudinal direction of the line head 29 is substantially parallel to the main scanning direction MD. The line head includes a plurality of light emitting elements arrayed in the longitudinal direction and is positioned separated from the photosensitive drum 21. Light beams are emitted from these light emitting elements to irradiate (in other words, expose) the surface of the photosensitive drum 21 charged by the charger 23, thereby forming a latent image on this surface. The head controller HC is provided to control the line heads 29 of the respective colors, and controls the respective line heads 29 based on the video data VD from the main controller MC and a signal from the engine controller EC. Specifically, image data included in an image formation command is inputted to an image processor 51 of the main controller MC. Then, video data VD of the respective colors are generated by applying various image processings to the image data, and the video data VD are fed to the head controller HC via a main-side communication module 52. In the head controller HC, the video data VD are fed to a head control module 54 via a head-side communication module 53. Signals representing parameter values relating to the formation of a latent image and the vertical synchronization signal Vsync are fed to this head control module 54 from the engine controller EC as described above. Based on these signals, the video data VD and the like, the head controller HC generates signals for controlling the driving of the elements of the line heads 29 of the respective colors and outputs them to the respective line heads 29. In this way, the operations of the light emitting elements in the respective line heads 29 are suitably controlled to form latent images corresponding to the image formation command.

The photosensitive drum 21, the charger 23, the developer 25 and the photosensitive drum cleaner 27 of each of the image forming stations Y, M, C and K are unitized as a photosensitive cartridge. Further, each photosensitive cartridge includes a nonvolatile memory for storing information on the photosensitive cartridge. Wireless communication is performed between the engine controller EC and the respective photosensitive cartridges. By doing so, the information on the respective photosensitive cartridges is transmitted to the engine controller EC and information in the respective memories can be updated and stored.

The developer 25 includes a developing roller 251 carrying toner on the surface thereof. By a development bias applied to the developing roller 251 from a development bias generator (not shown) electrically connected to the developing roller 251, charged toner is transferred from the developing roller 251 to the photosensitive drum 21 to develop the latent image formed by the line head 29 at a development position where the developing roller 251 and the photosensitive drum 21 are in contact.

The toner image developed at the development position in this way is primarily transferred to the transfer belt 81 at a primary transfer position TR1 to be described later where the transfer belt 81 and each photosensitive drum 21 are in contact after being transported in the rotating direction D21 of the photosensitive drum 21.

Further, the photosensitive drum cleaner 27 is disposed in contact with the surface of the photosensitive drum 21 downstream of the primary transfer position TR1 and upstream of the charger 23 with respect to the rotating direction D21 of the photosensitive drum 21. This photosensitive drum cleaner 27 removes the toner remaining on the surface of the photosensitive drum 21 to clean after the primary transfer by being held in contact with the surface of the photosensitive drum.

The transfer belt unit 8 includes a driving roller 82, a driven roller (blade facing roller) 83 arranged to the left of the driving roller 82 in FIG. 1, and the transfer belt 81 mounted on these rollers. The transfer belt unit 8 also includes four primary transfer rollers 85Y, 85M, 85C and 85K arranged to face in a one-to-one relationship with the photosensitive drums 21 of the respective image forming stations Y, M, C and K inside the transfer belt 81 when the photosensitive cartridges are mounted. These primary transfer rollers 85Y, 85M, 85C and 85K are respectively electrically connected to a primary transfer bias generator not shown. As described in detail later, at the time of executing the color mode, all the primary transfer rollers 85Y, 85M, 85C and 85K are positioned on the sides of the image forming stations Y, M, C and K as shown in FIG. 1, whereby the transfer belt 81 is pressed into contact with the photosensitive drums 21 of the image forming stations Y, M, C and K to form the primary transfer positions TR1 between the respective photosensitive drums 21 and the transfer belt 81. By applying primary transfer biases from the primary transfer bias generator to the primary transfer rollers 85Y, 85M, 85C and 85K at suitable timings, the toner images formed on the surfaces of the respective photosensitive drums 21 are transferred to the surface of the transfer belt 81 at the corresponding primary transfer positions TR1 to form a color image.

On the other hand, out of the four primary transfer rollers 85Y, 85M, 85C and 85K, the color primary transfer rollers 85Y, 85M, 85C are separated from the facing image forming stations Y, M and C and only the monochromatic primary transfer roller 85K is brought into contact with the image forming station K at the time of executing the monochromatic mode, whereby only the monochromatic image forming station K is brought into contact with the transfer belt 81. As a result, the primary transfer position TR1 is formed only between the monochromatic primary transfer roller 85K and the image forming station K. By applying a primary transfer bias at a suitable timing from the primary transfer bias generator to the monochromatic primary transfer roller 85K, the toner image formed on the surface of the photosensitive drum 21 is transferred to the surface of the transfer belt 81 at the primary transfer position TR1 to form a monochromatic image.

The transfer belt unit 8 further includes a downstream guide roller 86 disposed downstream of the monochromatic primary transfer roller 85K and upstream of the driving roller 82. This downstream guide roller 86 is so disposed as to come into contact with the transfer belt 81 on an internal common tangent to the primary transfer roller 85K and the photosensitive drum 21 at the primary transfer position TR1 formed by the contact of the monochromatic primary transfer roller 85K with the photosensitive drum 21 of the image forming station K.

The driving roller 82 drives to rotate the transfer belt 81 in the direction of the arrow D81 and doubles as a backup roller for a secondary transfer roller 121. A rubber layer having a thickness of about 3 mm and a volume resistivity of 1000 kΩ·cm or lower is formed on the circumferential surface of the driving roller 82 and is grounded via a metal shaft, thereby serving as an electrical conductive path for a secondary transfer bias to be supplied from an unillustrated secondary transfer bias generator via the secondary transfer roller 121. By providing the driving roller 82 with the rubber layer having high friction and shock absorption, an impact caused upon the entrance of a sheet into a contact part (secondary transfer position TR2) of the driving roller 82 and the secondary transfer roller 121 is unlikely to be transmitted to the transfer belt 81 and image deterioration can be prevented.

The sheet feeding unit 11 includes a sheet feeding section which has a sheet cassette 77 capable of holding a stack of sheets, and a pickup roller 79 which feeds the sheets one by one from the sheet cassette 77. The sheet fed from the sheet feeding section by the pickup roller 79 is fed to the secondary transfer position TR2 along the sheet guiding member 15 after having a sheet feed timing adjusted by a pair of registration rollers 80.

The secondary transfer roller 121 is provided freely to abut on and move away from the transfer belt 81, and is driven to abut on and move away from the transfer belt 81 by a secondary transfer roller driving mechanism (not shown). The fixing unit 13 includes a heating roller 131 which is freely rotatable and has a heating element such as a halogen heater built therein, and a pressing section 132 which presses this heating roller 131. The sheet having an image secondarily transferred to the front side thereof is guided by the sheet guiding member 15 to a nip portion formed between the heating roller 131 and a pressure belt 1323 of the pressing section 132, and the image is thermally fixed at a specified temperature in this nip portion. The pressing section 132 includes two rollers 1321 and 1322 and the pressure belt 1323 mounted on these rollers. Out of the surface of the pressure belt 1323, a part stretched by the two rollers 1321 and 1322 is pressed against the circumferential surface of the heating roller 131, thereby forming a sufficiently wide nip portion between the heating roller 131 and the pressure belt 1323. The sheet having been subjected to the image fixing operation in this way is transported to the discharge tray 4 provided on the upper surface of the housing main body 3.

Further, a cleaner 71 is disposed facing the blade facing roller 83 in this apparatus. The cleaner 71 includes a cleaner blade 711 and a waste toner box 713. The cleaner blade 711 removes foreign matters such as toner remaining on the transfer belt after the secondary transfer and paper powder by holding the leading end thereof in contact with the blade facing roller 83 via the transfer belt 81. Foreign matters thus removed are collected into the waste toner box 713. Further, the cleaner blade 711 and the waste toner box 713 are constructed integral to the blade facing roller 83. Accordingly, if the blade facing roller 83 moves as described next, the cleaner blade 711 and the waste toner box 713 move together with the blade facing roller 83.

II. Construction of Line Head

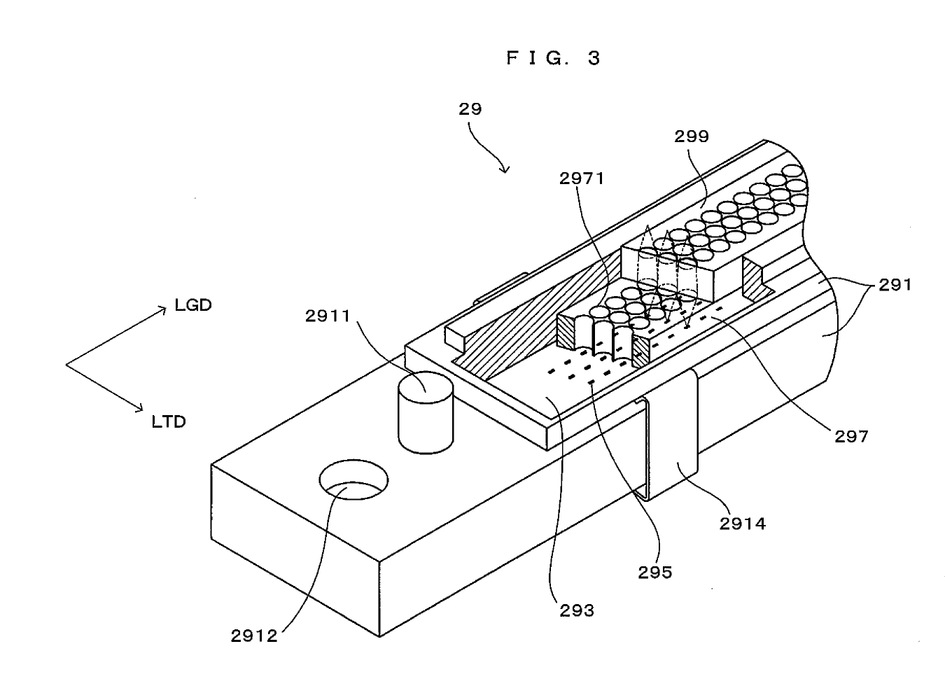

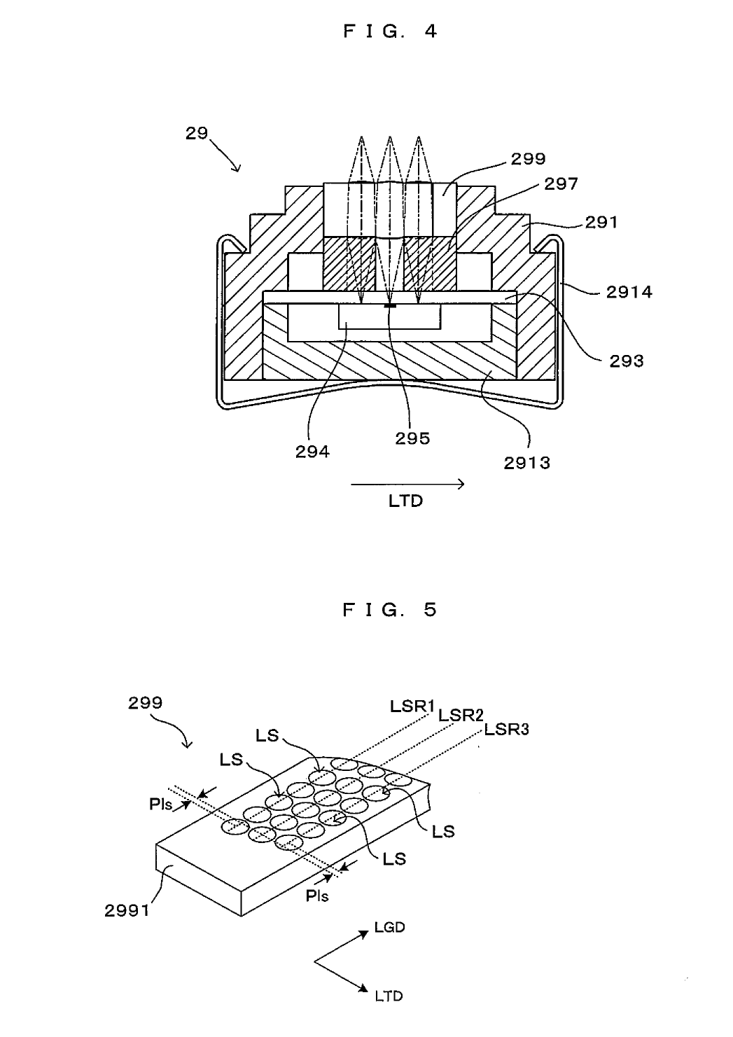

FIG. 3 is a perspective view schematically showing a line head, and FIG. 4 is a sectional view along a width direction of the line head shown in FIG. 3. As described above, the line head 29 is arranged to face the photosensitive drum 21 such that the longitudinal direction LGD corresponds to the main scanning direction MD and the width direction LTD corresponds to the sub scanning direction SD. The longitudinal direction LGD and the width direction LTD are normal to or substantially normal to each other. Hence, the longitudinal direction LGD is parallel to or substantially parallel to the main scanning direction MD while the width direction LTD is parallel to or substantially parallel to the sub scanning direction SD. The line head 29 of this embodiment includes a case 291, and a positioning pin 2911 and a screw insertion hole 2912 are provided at each of the opposite ends of such a case 291 in the longitudinal direction LGD. The line head 29 is positioned relative to the photosensitive drum 21 by fitting such positioning pins 2911 into positioning holes (not shown) perforated in a photosensitive drum cover (not shown) covering the photosensitive drum 21 and positioned relative to the photosensitive drum 21. Further, the line head 29 is positioned and fixed relative to the photosensitive drum 21 by screwing fixing screws into screw holes (not shown) of the photosensitive drum cover via the screw insertion holes 2912 to be fixed.

The case 291 carries a lens array 299 at a position facing the surface of the photosensitive drum 21, and includes a light shielding member 297 and a head substrate 293 inside, the light shielding member 297 being closer to the lens array 299 than the head substrate 293. The head substrate 293 is made of a transmissive material (glass for instance). Further, a plurality of light emitting element groups 295 are provided on an under surface of the head substrate 293 (surface opposite to the lens array 299 out of two surfaces of the head substrate 293). Specifically, the plurality of light emitting element groups 295 are two-dimensionally arranged on the under surface of the head substrate 293 while being spaced by specified distances in the longitudinal direction LGD and the width direction LTD. Here, each light emitting element group 295 is formed by two-dimensionally arraying a plurality of light emitting elements. This will be described in detail later. Bottom emission-type EL (electroluminescence) devices are used as the light emitting elements. In other words, the organic EL devices are arranged as light emitting elements on the under surface of the head substrate 293. Thus, all the light emitting elements 2951 are arranged on the same plane (under surface of the head substrate 293). When the respective light emitting elements are driven by a drive circuit formed on the head substrate 293, light beams are emitted from the light emitting elements in directions toward the photosensitive drum 21. These light beams propagate toward the light shielding member 297 after passing through the head substrate 293 from the under surface thereof to a top surface thereof.

The light shielding member 297 is perforated with a plurality of light guide holes 2971 in a one-to-one correspondence with the plurality of light emitting element groups 295. The light guide holes 2971 are substantially cylindrical holes penetrating the light shielding member 297 and having central axes in parallel with normals to the head substrate 293. Accordingly, out of light beams emitted from the light emitting element groups 295, those propagating toward other than the light guide holes 2971 corresponding to the light emitting element groups 295 are shielded by the light shielding member 297. In this way, all the lights emitted from one light emitting element group 295 propagate toward the lens array 299 via the same light guide hole 2971 and the mutual interference of the light beams emitted from different light emitting element groups 295 can be prevented by the light shielding member 297. The light beams having passed through the light guide holes 2971 perforated in the light shielding member 297 are imaged as spots on the surface of the photosensitive drum 21 by the lens array 299.

As described above, in this embodiment, some lights out of lights being emitted from the light emitting elements 2951 pass through the light guide holes 2971 formed in the light shielding member 297. The some lights are incident on the lenses LS and contribute to image formation. In other words, the lights incident on the lenses LS and contributing to image formation are restricted by the light shielding member 297. Accordingly, a problem of disturbing the formed image by stray lights and the like is suppressed by the light shielding member 297, and a detection image such as a registration mark RM to be described later can be satisfactorily formed. By detecting a detection image satisfactorily formed in this way, the detection result on the detection image can be made stable.

As shown in FIG. 4, an underside lid 2913 is pressed against the case 291 via the head substrate 293 by retainers 2914. Specifically, the retainers 2914 have elastic forces to press the underside lid 2913 toward the case 291, and seal the inside of the case 291 light-tight (that is, so that light does not leak from the inside of the case 291 and so that light does not intrude into the case 291 from the outside) by pressing the underside lid by means of the elastic force. It should be noted that a plurality of the retainers 2914 are provided at a plurality of positions in the longitudinal direction of the case 291. The light emitting element groups 295 are covered with a sealing member 294.

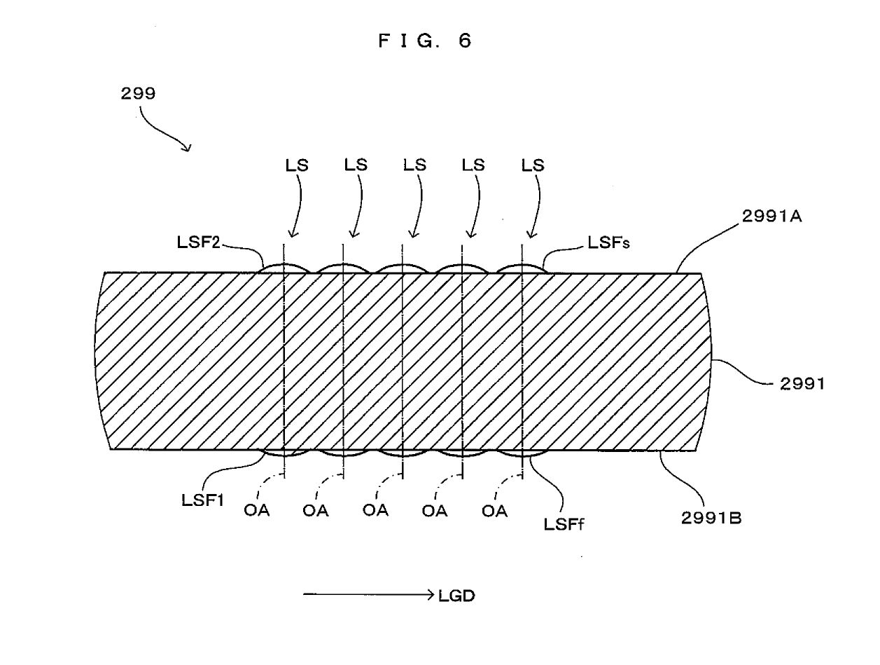

FIG. 5 is a schematic partial perspective view of the lens array, and FIG. 6 is a sectional view of the lens array in the longitudinal direction LGD. The lens array 299 includes a lens substrate 2991. First surfaces LSFf of lenses LS are formed on an under surface 2991B of the lens substrate 2991, and second surfaces LSFs of the lenses LS are formed on a top surface 2991A of the lens substrate 2991. The first and second surfaces LSFf, LSFs facing each other and the lens substrate 2991 held between these two surfaces function as one lens LS. The first and second surfaces LSFf, LSFs of the lenses LS can be made of resin for instance.

The lens array 299 is arranged such that optical axes OA of the plurality of lenses LS are substantially parallel to each other. The lens array 299 is also arranged such that the optical axes OA of the lenses LS are substantially normal to the under surface (surface where the light emitting elements 2951 are arranged) of the head substrate 293. At this time, these plurality of lenses LS are arranged in a one-to-one correspondence with the plurality of light emitting element groups 295 to be described later. In other words, the plurality of lenses LS are two-dimensionally arranged at specified intervals in the longitudinal direction LGD and the width direction LTD in correspondence with the arrangement of the light emitting element groups 295 to be described later, and focus the lights from the corresponding light emitting element groups 295 to expose the surface of the photosensitive drum 21. These respective lenses LS are arranged as follows. Specifically, a plurality of lens rows LSR, in each of which a plurality of lenses LS are aligned in the longitudinal direction LGD, are arranged in the width direction LTD. In this embodiment, three lens rows LSR1, LSR2, LSR3 are arranged in the width direction LTD. The three lens rows LSR1 to LSR3 are arranged at specified lens pitches Pls in the longitudinal direction, so that the positions of the respective lenses LS differ in the longitudinal direction LGD. In this way, the respective lenses LS can expose regions mutually different in the main scanning direction NM.

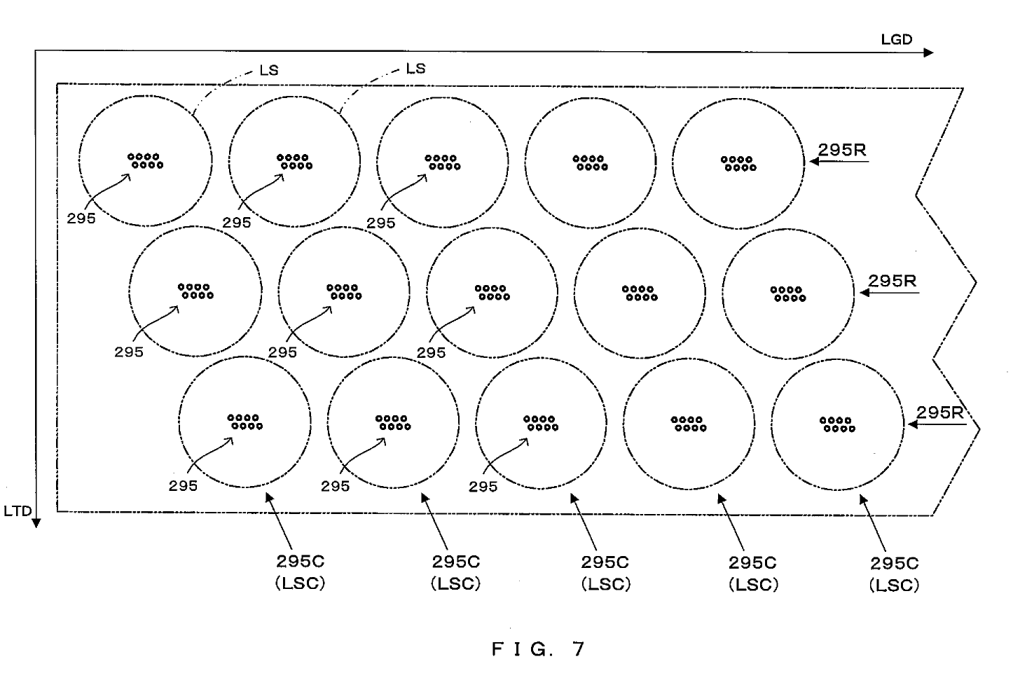

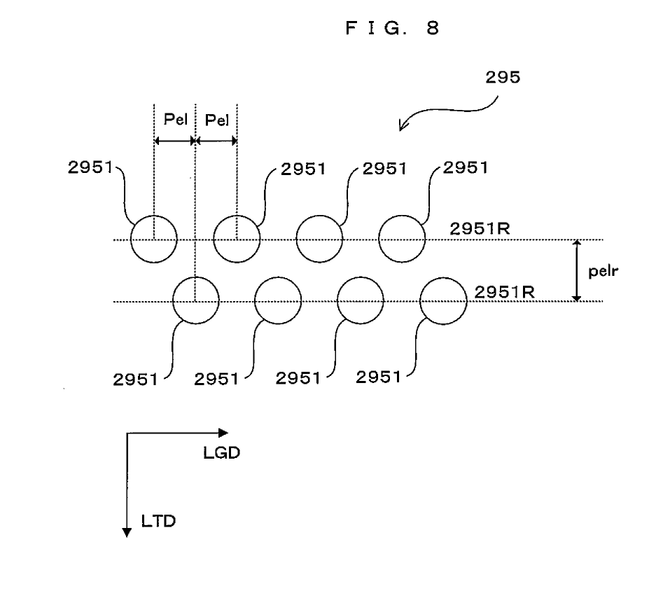

FIG. 7 is a diagram showing the arrangement of the light emitting element groups in the line head, and FIG. 8 is a diagram showing the arrangement of the light emitting elements in each light emitting element group. The construction of the respective light emitting element groups will be described with reference to FIGS. 7 and 8. Eight light emitting elements 2951 are aligned at specified element pitches Pel in the longitudinal direction LGD in each light emitting element group 295. In each light emitting element group 295, two light emitting element rows 2951R each formed by aligning four light emitting elements 2951 at specified pitches (twice the element pitch Pel) in the longitudinal direction LGD are arranged while being spaced apart by an element row pitch Pelr in the width direction LTD. As a result, eight light emitting elements 2951 are arranged in a staggered manner in each of the light emitting element groups 295. The plurality of light emitting element groups 295 are arranged as follows.

Specifically, a plurality of light emitting element groups 295 are arranged such that a plurality of light emitting element group columns 295C, in each of which three light emitting element groups 295 are offset from each other in the width direction LTD and the longitudinal direction LGD, are arranged in the longitudinal direction LGD. Further, in conformity with such an arrangement of the light emitting element groups, a plurality of lens columns LSC, in each of which three lenses LS are offset from each other in the width direction LTD and the longitudinal direction LGD, are arranged in the longitudinal direction LGD in the lens array 299. The longitudinal-direction positions of the respective light emitting element groups 295 differ from each other, so that the respective light emitting element groups 295 can expose mutually different regions in the main scanning direction MD. A plurality of light emitting element groups 295 arranged in the longitudinal direction LGD (in other words, a plurality of light emitting element groups 295 arranged at the same width-direction position) are particularly defined as a light emitting element group row 295R. In this specification, it is defined that the position of each light emitting element is the geometric center of gravity thereof and that the position of the light emitting element group 295 is the geometric center of gravity of the positions of all the light emitting elements belonging to the same light emitting element group 295. The longitudinal-direction position and the width-direction position mean a longitudinal-direction component and a width-direction component of a particular position, respectively.

The detailed mutual relationship of the light emitting element groups 295, the light guide holes 2971 and the lenses LS is as follows. Specifically, the light guide holes 2971 are perforated in the light shielding member 297 and the lenses LS are arranged in conformity with the arrangement of the light emitting element groups 295. At this time, the center of gravity position of the light emitting element groups 295, the center axes of the light guide holes 2971 and the optical axes OA of the lenses LS substantially coincide. Accordingly, light beams emitted from the light emitting elements 2951 of the light emitting element groups 295 are incident on the lenses LS of the lens array 299 through the light guide holes 2971. Spots are formed on the surface of the photosensitive drum 21 (photosensitive member surface) by imaging these incident light beams by the lenses LS, whereby the surface of the photosensitive member is exposed. A latent image is formed in the thus exposed part.

III. Terminology in Line Head

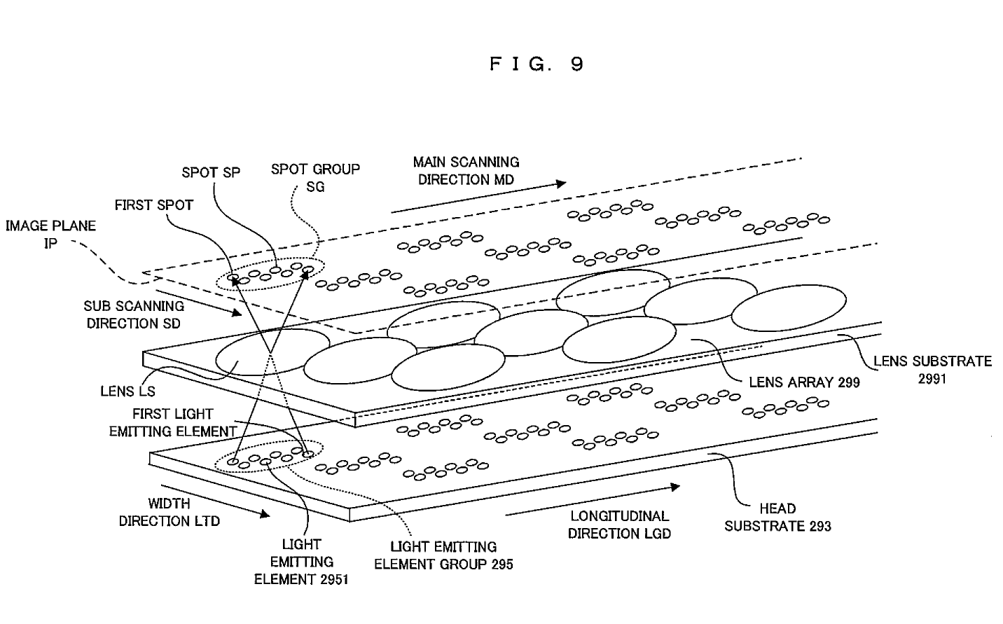

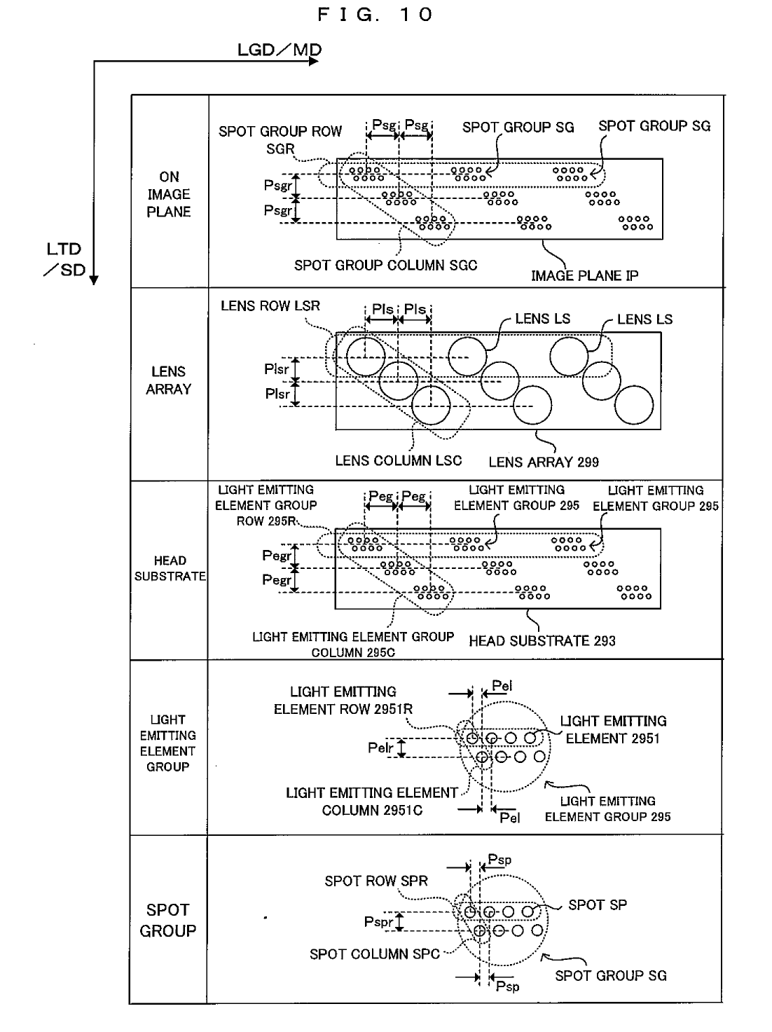

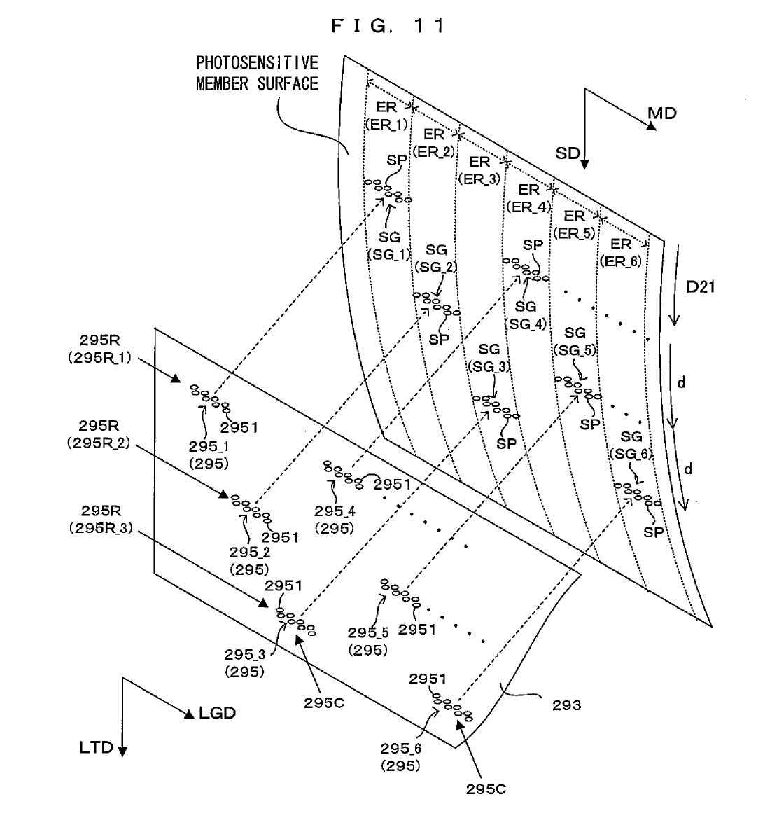

FIGS. 9 and 10 are diagrams showing terminology used in this specification. Here, terminology used in this specification is organized with reference to FIGS. 9 and 10. In this specification, as described above, a conveying direction of the surface (image plane IP) of the photosensitive drum 21 is defined to be the sub scanning direction SD and a direction substantially normal to the sub scanning direction SD is defined to be the main scanning direction MD. Further, a line head 29 is arranged relative to the surface (image plane IP) of the photosensitive drum 21 such that its longitudinal direction LGD corresponds to the main scanning direction MD and its width direction LTD corresponds to the sub scanning direction SD.

Collections of a plurality of (eight in FIGS. 9 and 10) light emitting elements 2951 arranged on the head substrate 293 in one-to-one correspondence with the plurality of lenses LS of the lens array 299 are defined to be light emitting element groups 295. In other words, in the head substrate 293, the plurality of light emitting element groups 295 including a plurality of light emitting elements 2951 are arranged in conformity with the plurality of lenses LS, respectively. Further, collections of a plurality of spots SP formed on the image plane IP by imaging light beams from the light emitting element groups 295 toward the image plane IP by the lenses LS corresponding to the light emitting element groups 295 are defined to be spot groups SG. In other words, a plurality of spot groups SG can be formed in one-to-one correspondence with the plurality of light emitting element groups 295. In each spot group SG, the most upstream spot in the main scanning direction MD and the sub scanning direction SD is particularly defined to be a first spot. The light emitting element 2951 corresponding to the first spot is particularly defined to be a first light emitting element. Each of the lenses LS has a negative optical magnification to reverse the light beams from the light emitting element group 295 corresponding thereto and form spot group SG.

Further, spot group rows SGR and spot group columns SGC are defined as shown in the column “On Image Plane” of FIG. 10. Specifically, a plurality of spot groups SG aligned in the main scanning direction MD is defined to be the spot group row SGR. A plurality of spot group rows SGR are arranged at specified spot group row pitches Psgr in the sub scanning direction SD. Further, a plurality of (three in FIG. 10) spot groups SG arranged at the spot group row pitches Psgr in the sub scanning direction SD and at spot group pitches Psg in the main scanning direction MD are defined to be the spot group column SGC. It should be noted that the spot group row pitch Psgr is a distance in the sub scanning direction SD between the geometric centers of gravity of the two spot group rows SGR side by side with the same pitch and that the spot group pitch Psg is a distance in the main scanning direction MD between the geometric centers of gravity of the two spot groups SG side by side with the same pitch.

Lens rows LSR and lens columns LSC are defined as shown in the column of “Lens Array” of FIG. 10. Specifically, a plurality of lenses LS aligned in the longitudinal direction LGD is defined to be the lens row LSR. A plurality of lens rows LSR are arranged at specified lens row pitches Plsr in the width direction LTD. Further, a plurality of (three in FIG. 10) lenses LS arranged at the lens row pitches Plsr in the width direction LTD and at lens pitches Pls in the longitudinal direction LGD are defined to be the lens column LSC. It should be noted that the lens row pitch Plsr is a distance in the width direction LTD between the geometric centers of gravity of the two lens rows LSR side by side with the same pitch and that the lens pitch Pls is a distance in the longitudinal direction LGD between the geometric centers of gravity of the two lenses LS side by side with the same pitch.

Light emitting element group rows 295R and light emitting element group columns 295C are defined as in the column “Head Substrate” of FIG. 10. Specifically, a plurality of light emitting element groups 295 aligned in the longitudinal direction LGD is defined to be the light emitting element group row 295R. A plurality of light emitting element group rows 295R are arranged at specified light emitting element group row pitches Pegr in the width direction LTD. Further, a plurality of (three in FIG. 10) light emitting element groups 295 arranged at the light emitting element group row pitches Pegr in the width direction LTD and at light emitting element group pitches Peg in the longitudinal direction LGD are defined to be the light emitting element group column 295C. It should be noted that the light emitting element group row pitch Pegr is a distance in the width direction LTD between the geometric centers of gravity of the two light emitting element group rows 295R side by side with the same pitch and that the light emitting element group pitch Peg is a distance in the longitudinal direction LGD between the geometric centers of gravity of the two light emitting element groups 295 side by side with the same pitch.

Light emitting element rows 2951R and light emitting element columns 2951C are defined as in the column “Light emitting element Group” of FIG. 10. Specifically, in each light emitting element group 295, a plurality of light emitting elements 2951 aligned in the longitudinal direction LGD is defined to be the light emitting element row 2951R. A plurality of light emitting element rows 2951R are arranged at specified light emitting element row pitches Pelr in the width direction LTD. Further, a plurality of (two in FIG. 10) light emitting elements 2951 arranged at the light emitting element row pitches Pelr in the width direction LTD and at light emitting element pitches Pel in the longitudinal direction LGD are defined to be the light emitting element column 2951C. It should be noted that the light emitting element row pitch Pelr is a distance in the width direction LTD between the geometric centers of gravity of the two light emitting element rows 2951R side by side with the same pitch and that the light emitting element pitch Pel is a distance in the longitudinal direction LGD between the geometric centers of gravity of the two light emitting elements 2951 side by side with the same pitch.

Spot rows SPR and spot columns SPC are defined as shown in the column “Spot Group” of FIG. 10. Specifically, in each spot group SG, a plurality of spots SG aligned in the longitudinal direction LGD is defined to be the spot row SPR. A plurality of spot rows SPR are arranged at specified spot row pitches Pspr in the width direction LTD. Further, a plurality of (two in FIG. 10) spots arranged at the spot row pitches Pspr in the width direction LTD and at spot pitches Psp in the longitudinal direction LGD are defined to be the spot column SPC. It should be noted that the spot row pitch Pspr is a distance in the sub scanning direction SD between the geometric centers of gravity of the two spot rows SPR side by side with the same pitch and that the spot pitch Psp is a distance in the main scanning direction MD between the geometric centers of gravity of the two spots SP side by side with the same pitch.

IV. Exposure Operation by Line Head

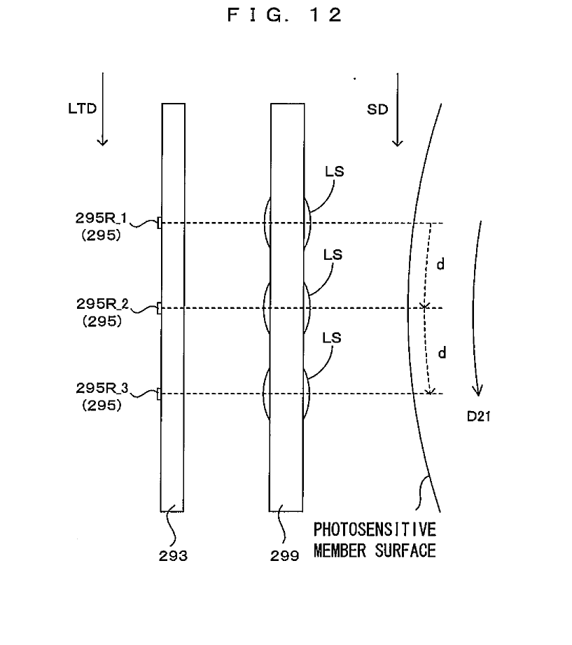

FIG. 11 is a perspective view showing an exposure operation by the line head. As described above, the exposure operation is performed by the lenses LS imaging the lights from the light emitting element groups 295. In FIG. 11, the lens array is not shown. The spot groups SG described next are formed on the surface of the photosensitive member by imaging the lights from the light emitting element groups 295 by the lenses LS. However, in the following description, the imaging operations of the lenses LS are omitted if necessary and it is merely described that “the light emitting element groups 295 form the spot groups SG” in order to facilitate the understanding of the exposure operation. As shown in FIG. 11, the respective light emitting element groups 295 can expose mutually different regions ER (ER1 to ER6). For example, the light emitting element group 295_1 forms the spot group SG_1 on the surface of the photosensitive member moving in the sub scanning direction SD (moving direction D21) by emitting light beams from the respective light emitting elements 2951. In this way, the light emitting element group 2951_1 can expose the region ER_1 of a specified width in the main scanning direction MD. Similarly, the light emitting element groups 295_2 to 295_6 can exposure the regions ER_2 to ER_6.

In the line head 29, the light emitting element group column 295C is formed by offsetting three light emitting element groups 295 from each other in the width direction LTD and the longitudinal direction LGD. For example, as shown in FIG. 11, the light emitting element groups 295_1 to 295_3 constituting the light emitting element group column 295C are offset from each other in the width direction LTD. The three light emitting element groups 295 constituting the light emitting element group column 295C expose three consecutive exposure regions ER in the main scanning direction MD. In this way, the light emitting element group column 295C is formed by offsetting the light emitting element groups 295, which expose the three consecutive exposure regions ER in the main scanning direction MD, from each other in the width direction LTD. The positions of the spot groups SG formed by the light emitting element groups 295 also differ in the sub scanning direction SD in conformity with the offset arrangement of the light emitting element groups 295 in the width direction LTD.

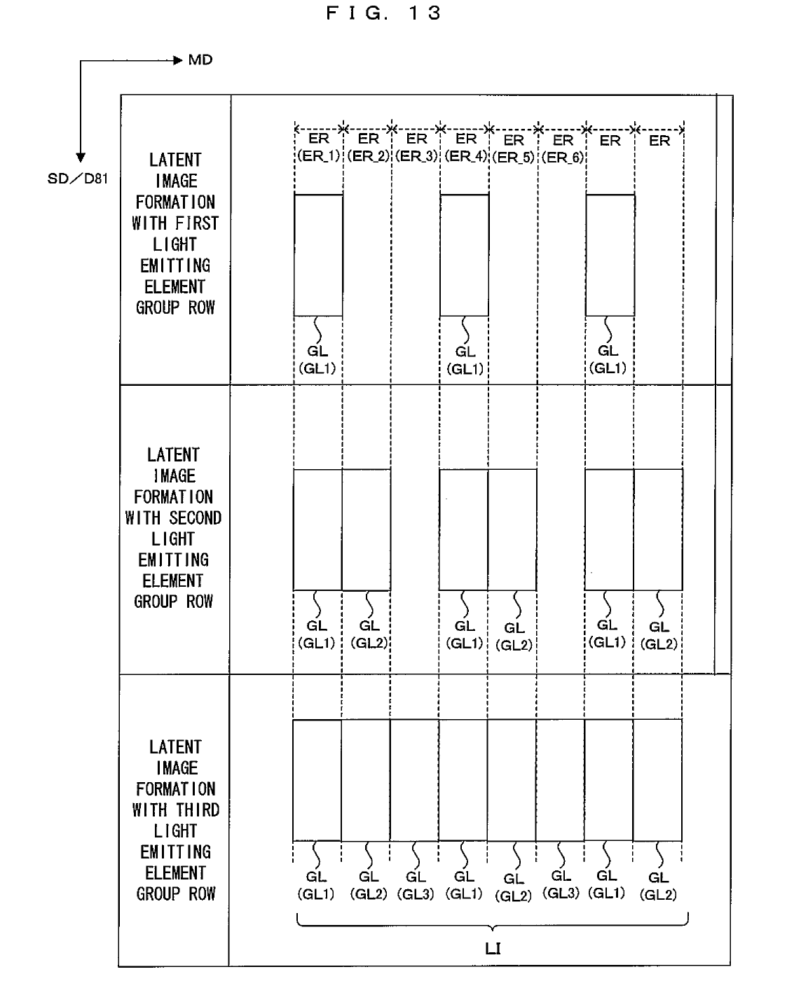

FIG. 12 is a side view showing the exposure operation by the line head. The exposure operation by the line head will be described with reference to FIGS. 11 and 12. As shown in FIGS. 11 and 12, the light emitting element groups 295 belonging to the same light emitting element group row 295R form the spot groups SG substantially at the same positions in the sub scanning direction SD (moving direction D21). On the other hand, the light emitting element groups belonging to the mutually different light emitting element group rows 295R form the spot groups SG at mutually different positions in the sub scanning direction SD (moving direction D21). In other words, the first light emitting element group row 295R_1 in the width direction LTD forms the spot groups SG_1, SG_4 at most upstream positions in the sub scanning direction SD. The second light emitting element group row 295R_2 forms the spot groups SG_2, SG_5 at positions downstream of these spot groups SG_1, SG_4 by a distance d. Further, the third light emitting element group row 295R_3 forms the spot groups SG_3, SG_6 at positions downstream of these spot groups SG_2, SG_5 by the distance d.

The formation positions of the spot groups SG in the sub scanning direction SD differ depending on the light emitting element groups 295. Accordingly, the respective light emitting element group rows 295R emit lights at mutually different timings to form the spot groups SG, for example, in the case of forming a latent image extending in the main scanning direction MD.

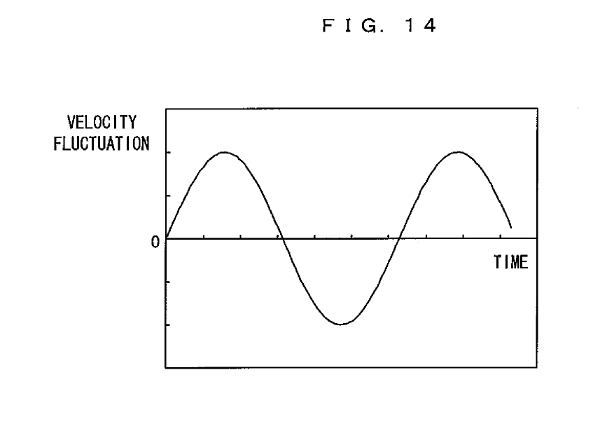

FIG. 13 is a diagram showing an example of a latent image forming operation by the line head. The example of the latent image forming operation by the line head will be described below with reference to FIGS. 11 to 13. First of all, the first light emitting element group row 295R_1 forms the spot groups SG for a specified period. Thus, group latent images GL1 of a specified width are formed in the regions ER_1, ER_4, . . . in the sub scanning direction SD. Here, the group latent image GL is a latent image formed by one light emitting element group 295. Subsequently, the second light emitting element group row 295R_2 forms the spot groups SG for the specified period at a timing at which the group latent images GL1 formed by the light emitting element group row 295R_1 are conveyed in the sub scanning direction SD by the distance d. Thus, group latent images GL2 of the specified width are formed in the regions ER_2, ER_5, . . . in the sub scanning direction SD. Further, the third light emitting element group row 295R_3 forms the spot groups SG for the specified period at a timing at which the latent images formed by the light emitting element group rows 295R_1, 295R_2 are conveyed in the sub scanning direction SD by the distance d. Thus, group latent images GL3 of the specified width are formed in the regions ER_3, ER_6, . . . in the sub scanning direction SD.

In this specification, the group latent images formed by the light emitting element group row 295R_1 (in other words, by the lens row LSR1) are called group latent image GL1 and group toner images obtained by developing the group latent images GL1 are called group toner images GM1. Further, the group latent images formed by the light emitting element group row 295R_2 (in other words, by the lens row LSR2) are called group latent image GL2 and group toner images obtained by developing the group latent images GL2 are called group toner images GM2. Furthermore, the group latent images formed by the light emitting element group row 295R_3 (in other words, by the lens row LSR3) are called group latent image GL3 and group toner images obtained by developing the group latent images GL3 are called group toner images GM3.

The respective light emitting element group rows 295R emit lights at different timings in this way, whereby the positions of the group latent images GL formed by the respective light emitting element groups 295 in the sub scanning direction SD coincide with each other. The group latent images GL whose positions in the sub scanning direction SD coincide with each other are consecutively formed in the main scanning direction MD to form a latent image LI extending in the main scanning direction MD (see FIG. 13).

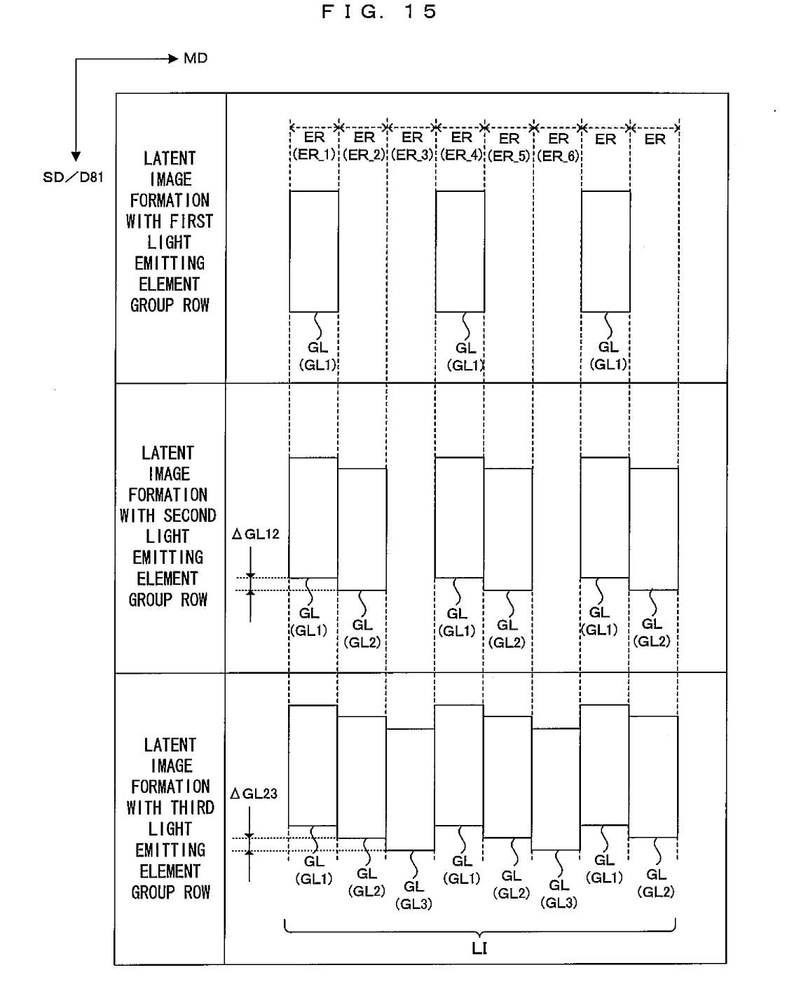

However, a moving speed of the surface of the photosensitive member may vary, for example, as shown in FIG. 14 in some cases due to the eccentricity of the photosensitive drum or the like. FIG. 14 is a graph showing a relationship between the speed variation of the moving speed of the surface of the photosensitive member and time. As a result, the positions of the group latent images GL1 to GL3 formed by the respective light emitting element groups 295_1 to 295_3 may vary in the sub scanning direction SD in some cases. In other words, the positions of three group latent images GL1 to GL3 consecutively formed in the main scanning direction MD may vary in the sub scanning direction SD in some cases.

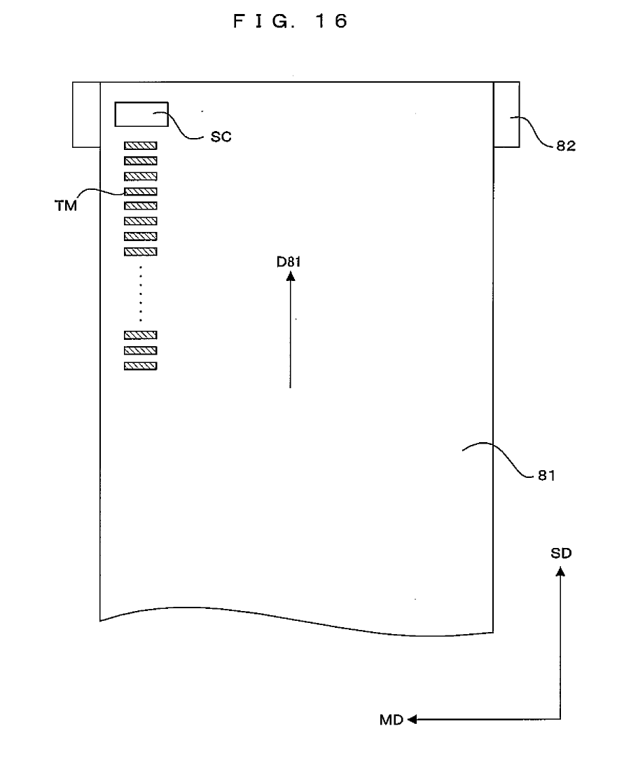

FIG. 15 is a diagram showing positional variations, which can occur in a latent image. As in the case shown in FIG. 13, the first light emitting element group row 295R_1 first forms the spot groups SG for the specified period to form the group latent images GL1. Subsequently, the second light emitting element group row 295R_2 forms the spot groups SG for the specified period to form the group latent images GL2. At this time, the group latent images GL2 are formed while being displaced from the group latent images GL1 by a distance ΔGL12 in the sub scanning direction SD due to the variation of the moving speed of the photosensitive member surface. Further, the third light emitting element group row 295R_3 forms the spot groups SG for the specified period to form the group latent images GL3. In this case as well, the group latent images GL3 are formed while being displaced from the group latent images GL2 by a distance ΔGL23 in the sub scanning direction SD due to the variation of the moving speed of the photosensitive member surface. In this way, the positions of three group latent images GL (GL1 to GL3) consecutively formed in the main scanning direction MD may vary in the sub scanning direction SD in some cases due to the moving speed variation of the surface of the photosensitive member.

If the above is summarized, the group column 295C is formed by displacing the respective N light emitting element groups 295, which can expose the areas consecutive in the main scanning direction MD, in the width direction LTD corresponding to the sub scanning direction SD in the above line head 29. Here, in this specification, N is the number of the light emitting element groups 295 constituting one light emitting element group column 295C (i.e. the number of the light emitting element group rows 295R). In the above line head 29, N=3. As described above, in the case of forming latent images by such a line head 29, the positions of the N group latent images GL consecutively formed in the main scanning direction MD may vary in the sub scanning direction SD in some cases. As a result, a similar variation occurs also in an image obtained by developing such latent images.

In order to satisfactorily perform an image forming operation, the above image forming apparatus 1 obtains image formation information relating to image formation beforehand in some cases. Although described in detail later, such image formation information includes color misregistration information, density information or information on the positional variation of the above N group latent images GL. These pieces of image formation information are obtained as follows. Specifically, a test image is formed and detected by an optical sensor and the image formation information is obtained from this detection result. In light of properly performing such a test image detection operation, it is preferable to reflect the positional variation of the N group latent images GL as described above on the detection result on the test image. Accordingly, as described in “V-1. First Example of Test Image Detection operation” to “V-3 Third Example of Test Image Detection operation”, the test image detection operation is properly performed by reflecting the positional variation of the N group latent images GL consecutive in the main scanning direction M on the detection result on the test image in the embodiment of the invention.

V-1. First Example of Test Image Detection Operation

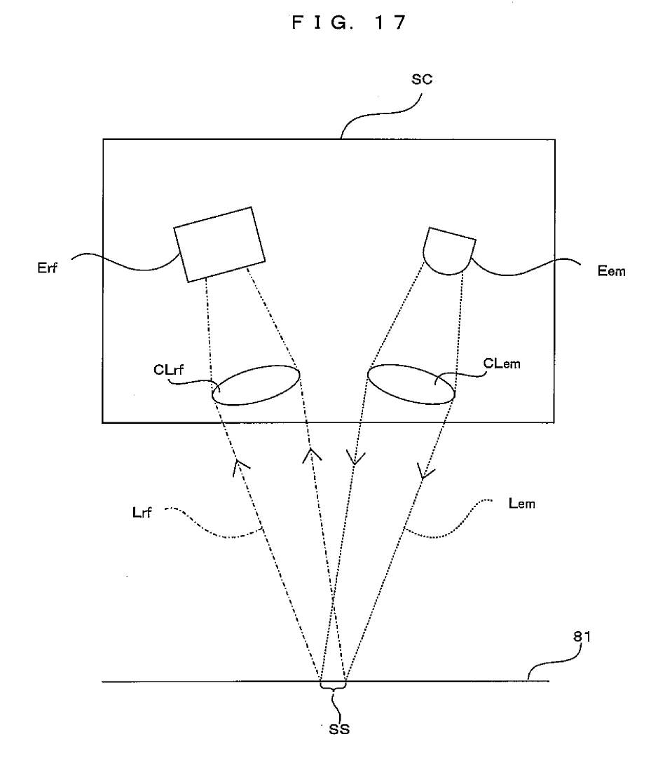

FIG. 16 is a diagram showing a construction for performing the test image detection operation and corresponds to a case when viewed vertically from below (from the lower side in FIG. 1). This test image detection operation is performed using an optical sensor SC. Specifically, the optical sensor SC is arranged to face a portion of the transfer belt 81 wounded about the driving roller 82. As shown in FIG. 16, the optical sensor SC is disposed at an end in the main scanning direction MO.

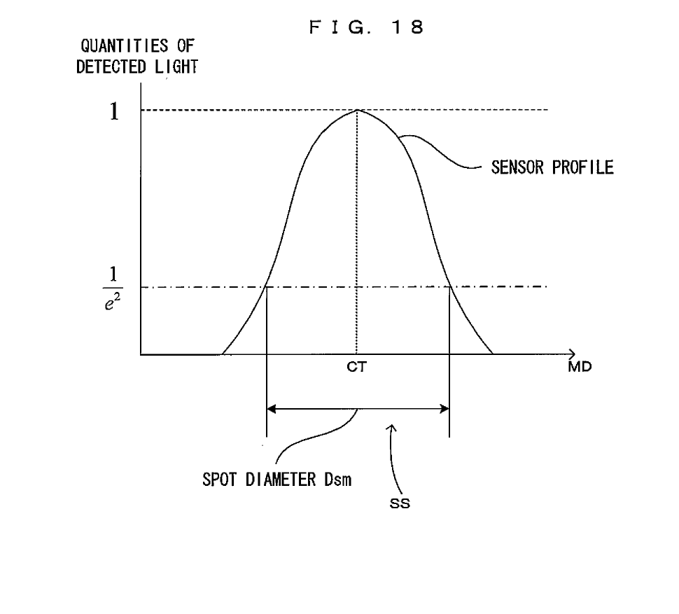

FIG. 17 is a diagram showing an example of the optical sensor. The optical sensor SC includes a light emitter Eem for emitting an irradiated light Lem toward the surface of the transfer belt 81 and a light receiver Erf for receiving a reflected light Lrf reflected by the transfer belt 81. The optical sensor SC further includes a condenser lens CLem for condensing the irradiated light Lem emitted from the light emitter Eem and a condenser lens CLrf for condensing the reflected light Lrf reflected by the surface of the transfer belt 81. Accordingly, the irradiated light Lem emitted from the light emitter Eem is condensed on the surface of the transfer belt 81 by the condenser lens CLem. Thus, a sensor spot SS is formed on the surface of the transfer belt 81. The reflected light Lrf reflected in an area of the sensor spot SS is condensed by the condenser lens CLrf to be detected by the light receiver Erf. In this way, the optical sensor SC detects an object on the sensor spot SS. Various optical sensors conventionally proposed can be used as the optical sensor SC. So-called distance limited reflective photoelectric sensors BGS (Back Ground Suppression) and the like may be used. Such BGSs include, for example, E3Z-LL61-F805M produced by Omron Corporation. This BGS detects an object located inside the sensor spot by projecting a light beam as a sensor spot.

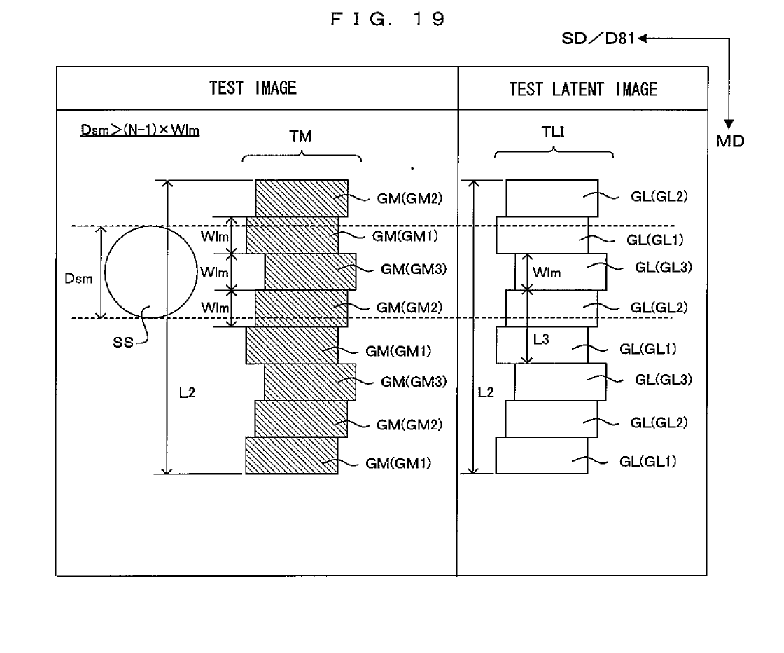

FIG. 18 is a graph of a sensor spot. An abscissa of FIG. 18 represents positions in the main scanning direction MD on the surface of the transfer belt 81. An ordinate of FIG. 18 represents the quantities of lights received (detected) by the light receiver Erf out of the reflected lights reflected at the positions represented by the abscissa on the surface of the transfer belt 81. If the quantities detected by the light receiver Erf out of the reflected lights at these positions are plotted with respect to the positions on the surface of the transfer belt 81, a sensor profile shown in FIG. 18 can be obtained. This sensor profile has a substantially laterally symmetrical distribution peaked at a profile center CT. The sensor spot SS is a range where the detected light quantity is equal to or above 1/e² (e is a base of natural logarithm) in the case of normalizing the sensor profile with a peak value set at 1. Accordingly, a spot diameter Dsm in the main scanning direction of the sensor spot SS corresponds to the length indicated by arrows in FIG. 18. As described above, in this embodiment, the sensor spot SS (detection area) is not determined by the light quantity distribution on the surface of the transfer belt 81, but by a detected light quantity distribution on the light receiver Erf. Although the sensor spot SS is described with respect to the main scanning direction MD here, the content of the sensor spot SS is similar also in the sub scanning direction SD. Referring back to FIG. 16, the description of the color misregistration correction operation is continued.

In the test image detection operation, test images TM are formed on the outer surface of the transfer belt 81 (FIG. 16). Specifically, test latent images are formed on the surfaces of the photosensitive drums 21 and are developed with toners to form the test images TM (test image forming step). These test images TM are transferred to the surface of the transfer belt 81. The test images TM formed on the transfer belt 81 in this way are conveyed in a conveying direction D81 to be detected by the optical sensor SC (test image detecting step).

FIG. 19 is a diagram showing a first example of the test image detection operation in the embodiment of the invention and corresponds to a case where N=3. In the first example of the test image detection operation, the widths of a test latent image TLI, a test image TM and the sensor spot SS in the main scanning direction MD are set according to the number N of the light emitting element groups 295 constituting the light emitting element group column 295C, i.e. the number N of the lenses LS constituting the lens column LSC. In other words, the test latent image TLI, the test image TM and the sensor spot SS have widths in the main scanning direction MD larger than the sum (=Wlm+Wlm) of the widths in the main scanning direction MD of images formed by (N-1) lenses LS adjacent in the main scanning direction MD and capable of exposure (e.g. group toner images GM1, GM2 or group toner images GM2, GM3, etc.). This is specifically as follows. As described above, in the test image detection operation, the test latent image TLI is first formed. In the first example shown in FIG. 19, this test latent image TLI is made up of N or more group latent images GL consecutive in the main scanning direction MD. Each of these group latent images GL is formed by all the light emitting elements 2951 belonging to one light emitting element group 295 and the test latent image TLI has a width equal to or larger than the N-fold of unit width Wlm in the main scanning direction MD. Here, the unit width Wlm is the width of the group latent image GL in the main scanning direction MD in the case of forming the group latent image GL by all the light emitting elements 2951 belonging to one light emitting element group 295. More specifically, in FIG. 19, the test latent image TLI is made up of eight group latent images GL consecutive in the main scanning direction MD and has a width (L2) eight times as large as the unit width Wlm in the main scanning direction MD.

The group latent images GL1 to GL3 constituting the test latent image TLI are developed to form the group toner images GM1 to GM3. In this way, the test latent image TLI is developed to form the test image TM. Such a test image TM also has the width L2 in the main scanning direction MD. This test image TM is conveyed in the conveying direction D81 to be detected at the sensor spot SS. In the first example shown in FIG. 19, the sensor spot SS has a main-scanning spot diameter Dsm larger than the (N-1)-fold of the unit width Wlm in the main scanning direction MD. Specifically, the main-scanning spot diameter Dsm of the sensor spot SS is larger than the twofold of the unit width Wlm.

As described above, in the first example shown in FIG. 19, the main-scanning spot diameter Dsm of the sensor spot SS is larger than a width (L3) which is the (N-1)-fold of the unit width Wlm. Accordingly, the operation of detecting the test image TM can be properly performed by reflecting the positional variation of the N group latent images GL consecutive in the main scanning direction MD on the detection result for the following reason.

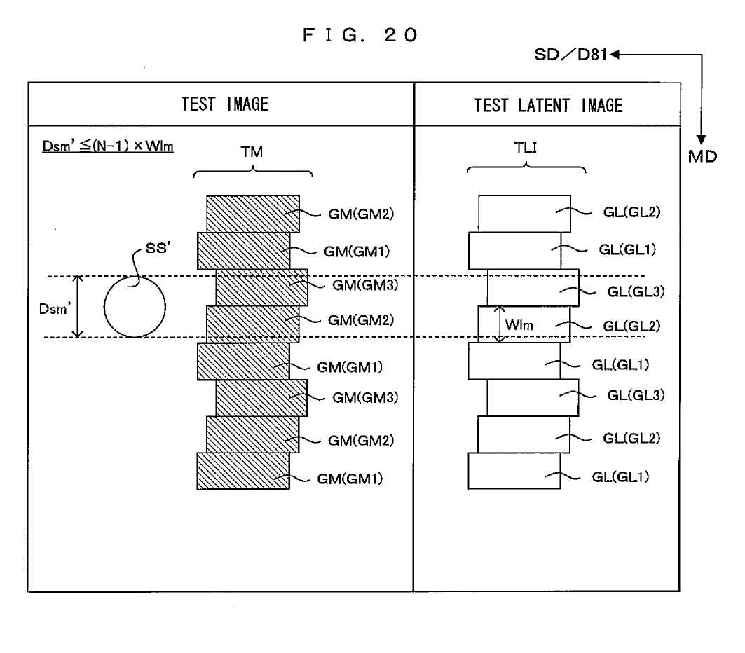

FIG. 20 is a diagram showing a case where a main-scanning spot diameter Dsm′ of the sensor spot is equal to or smaller than the (N-1)-fold of the unit width Wlm. Similar to the case of FIG. 19, FIG. 20 corresponds to a case where N=3. The main-scanning spot diameter Dsm′ of the sensor spot SS′ is equal to or smaller than the (N-1)-fold of the unit width Wlm. An optical sensor SC having the sensor spot SS′ detects a part passing the sensor spot SS′ out of the test image TM conveyed in the conveying direction D81. Specifically, the test image TM located between two broken lines sandwiching the sensor spot SS′ in FIG. 20 is detected. In the following description as well, a part to be detected by the sensor spot is similarly shown, using two broken lines sandwiching the sensor spot.

As shown in FIG. 20, the main-scanning spot diameter Dsm′ of the sensor spot SS′ is equal to or smaller than the (N-1)-fold of the unit width Wlm. As a result, the group toner images GM detected by the sensor spot SS′ are only (N-1) group toner images GM2, GM3 and the group toner image GM1 is not detected depending on the sensor spot SS′. Accordingly, the positional variation of the N group latent images GL (GL1 to GL3) consecutive in the main scanning direction MD is not reflected on the detection result on the test image TM by the sensor spot SS′. In this way, there are cases where the positional variation of the N group latent images GL (GL1 to GL3) consecutive in the main scanning direction MD is not reflected if the main-scanning spot diameter of the sensor spot is equal to or smaller than the (N-1)-fold of the unit width Wlm.

On the contrary, as shown in FIG. 19, the main-scanning spot diameter Dsm of the sensor spot SS1 in this embodiment is larger than the (N-1)-fold of the unit width Wlm. Accordingly, N group toner image GM (GM1 to GM3) consecutive in the main scanning direction MD can be reliably detected by the sensor spot SS as shown by broken lines in FIG. 19. Thus, the sensor spot SS shown in FIG. 19 is preferable since being able to detect the test image TM by reflecting the positional variation of N group latent images GL consecutive in the main scanning direction MD on the detection result.

V-2. Second Example of Test Image Detection Operation

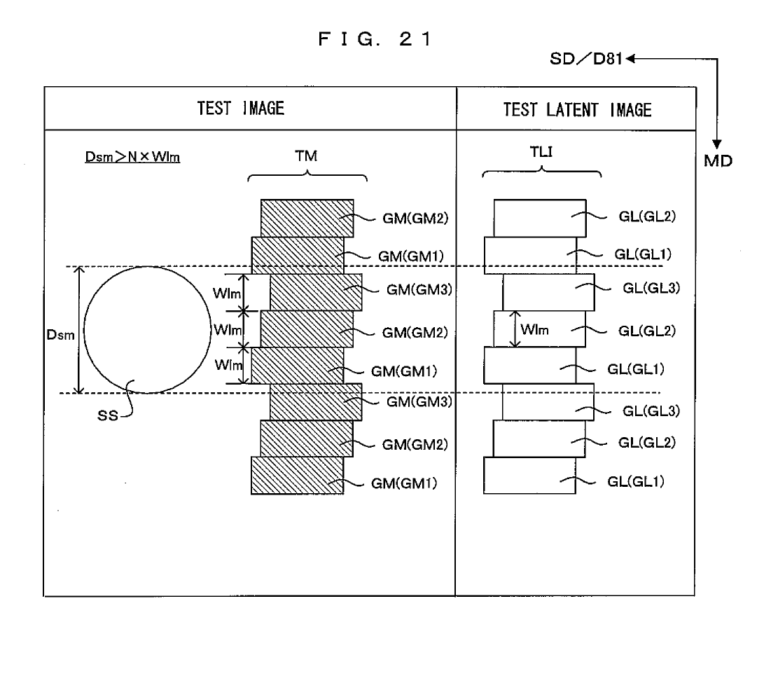

FIG. 21 is a diagram showing a second example of the test image detection operation according to the embodiment of the invention and corresponds to a case where N=3. Since the second example differs from the first example only in the main-scanning spot diameter Dsm of the sensor spot SS, only the point of difference will be described and common points will be not described below.

In the second example as well, a test latent image TLI, a test image TM and a sensor spot SS have widths in the main scanning direction MD larger than the sum (=Wlm+Wlm) of the widths in the main scanning direction MD of images formed by (N-1) lenses LS adjacent in the main scanning direction MD and capable of exposure (e.g. group toner images GM1, GM2 or group toner images GM2, GM3, etc.). Particularly in the second example, the sensor spot SS has a main-scanning spot diameter Dsm larger than the N-fold of the unit width Wlm. Accordingly, the test image TM can be more properly detected by sufficiently reflecting the positional variation of N group latent images GL (GL1 to GL3) consecutive in the main scanning direction MD on the detection result on the test image TM. The reason for this will be described with reference to FIGS. 19 and 21.

In FIGS. 19 and 21, all the N group toner images GM1 to GM3 consecutively formed in the main scanning direction MD have the width Wlm in the main scanning direction MD. However, in the first example shown in FIG. 19, the entire width Wlm of the group toner image GM2 in the main scanning direction MD passes the sensor spot SS, but only parts of the widths Wlm of the group toner image GM1, GM3 in the main scanning direction MD pass the sensor spot SS. On the contrary, in the second example shown in FIG. 21, the entire widths Wlm of all the group toner images GM1 to GM3 in the main scanning direction MD pass the sensor spot SS. Thus, the second example shown in FIG. 21 is preferable since being able to detect the test image TM by sufficiently reflecting the positional variation of N group latent images GL (GL1 to GL3) consecutive in the main scanning direction MD on the detection result.

V-3. Third Example of Test Image Detection Operation

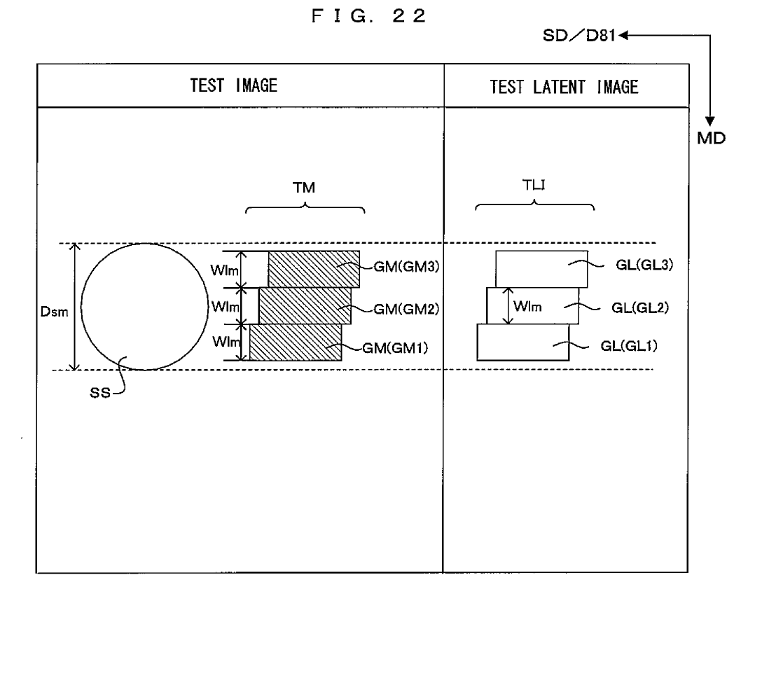

FIG. 22 is a diagram showing a third example of the test image detection operation according to the embodiment of the invention and corresponds to a case where N=3. Since the third example differs from the second example only in the configurations of the test latent image and the test image, only the points of difference will be described and common points will be not described below.

In the third example as well, a test latent image TLI, a test image TM and a sensor spot SS have widths in the main scanning direction MD larger than the sum (=Wlm+Wlm) of the widths in the main scanning direction MD of images formed by (N-1) lenses LS adjacent in the main scanning direction MD and capable of exposure (e.g. group toner images GM1, GM2 or group toner images GM2, GM3, etc.). Particularly in the third example shown in FIG. 22, the test latent image TLI has a width in the main scanning direction MD, which is equal to the N-fold of the unit width Wlm. This test latent image TLI is made up of N group latent images GL1 to GL3 consecutive in the main scanning direction MD, and each of the N group latent images GL1 to GL3 is formed by all the light emitting elements 2951 belonging to one light emitting element group 295. In other words, in FIG. 22, the test latent image TLI is formed by arranging N group latent images GL1 to GL3 each having the unit width Wlm in the main scanning direction MD. This test latent image TLI is developed to form the test image TM, and this test image TM is detected by the sensor spot SS.

As described above, in the third example shown in FIG. 22, the width of any of the N group latent images GL1 to GL3 in the main scanning direction MD is the unit width Wlm and equal. Accordingly, the influence of the group latent images GL1 to GL3 on the detection result of the optical sensor SC can be made substantially equal among the N group latent images GL1 to GL3. Therefore, the test image TM can be more properly detected.

VI-1. Color Misregistration Correction Operation

By performing the test image detection operation as described above, the test image TM can be properly detected by reflecting the positional variation of N group latent images GL consecutive in the main scanning direction MD on the detection result. Thus, by applying the above test image detection operation to a color misregistration correction operation, such a color misregistration correction operation can be satisfactorily performed. Accordingly, a case of applying the above test image detection operation to the color misregistration correction operation is described below. Particularly, a case of applying the first example of the test image detection operation to the color misregistration correction operation is described below.

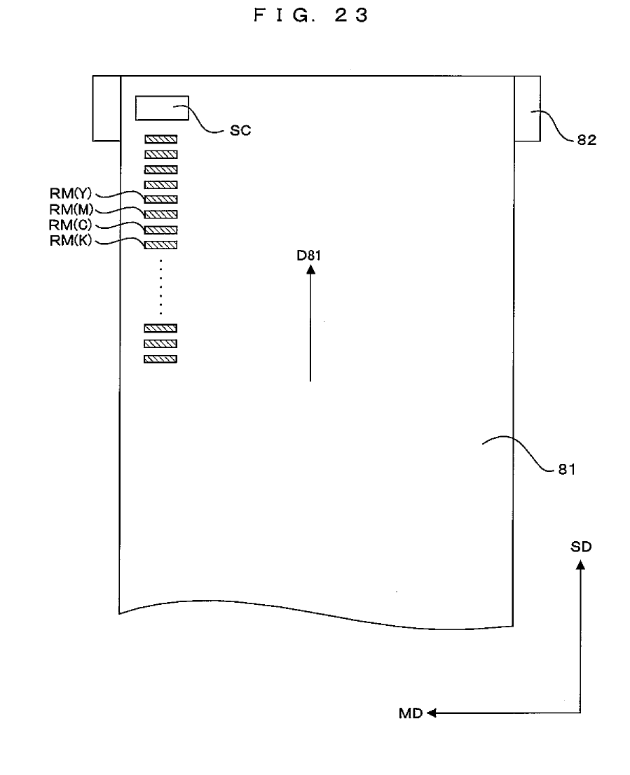

FIG. 23 is a diagram showing a construction for performing the color misregistration correction operation, and this diagram corresponds to a case when viewed vertically from below (from the lower side in FIG. 1). In the color misregistration correction operation, registration marks RM of the respective toner colors are formed as the test images TM. Specifically, the image forming stations Y, M, C and K form test latent images on the surfaces of the corresponding photosensitive drums 21 and develop these test images in the respective toner colors to form the registration marks RM(Y), RM(M), RM(C) and RM(K) as the test images. These registration marks RM are transferred to be arranged in a conveying direction D81 on the surface of the transfer belt 81. The registration marks RM thus formed on the transfer belt 81 are conveyed in the conveying direction D81 and detected by the optical sensors SC.

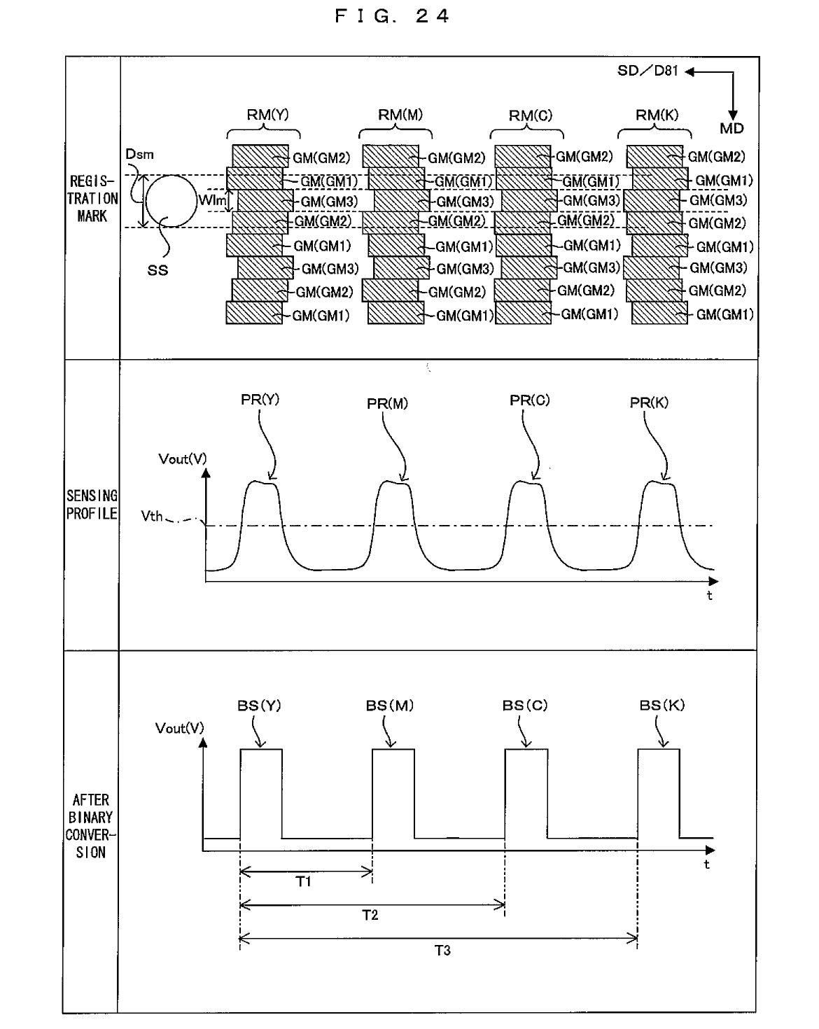

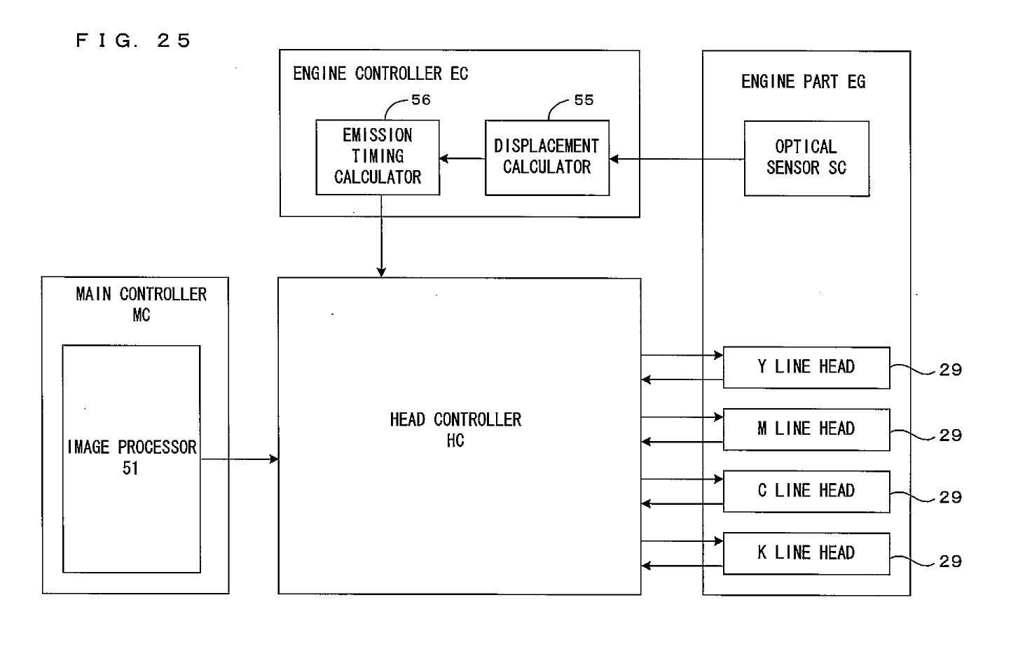

FIG. 24 is a diagram showing a process performed based on the detection result of the optical sensor, and FIG. 25 is a diagram showing an electrical construction for performing the process based on the detection result of the optical sensor As described above, the registration marks RM of the respective colors are formed side by side in the conveying direction D81 and pass the sensor spot SS by being conveyed in the conveying direction D81. In this way, the registration marks RM of the respective colors are detected by the optical sensor. This operation of detecting the registration marks RM is performed similar to the test image detection operation described in the above “V-1. First Example of Test Image Detection operation”.

In the row “SENSING PROFILE” of FIG. 24 is shown a detection result of the optical sensor SC. When the registration marks RM(Y), RM(M), RM(C) and RM(K) pass the sensor spot SS, the optical sensor SC outputs detected waveforms PR(Y), PR(M), PR(C) and PR(K) corresponding to the respective registration marks to a displacement calculator 55. These detected waveforms are outputted as voltage signals. This displacement calculator 55 and an emission timing calculator 56 to be described later are both provided in the engine controller EC.

In the displacement calculator 55, the detected waveforms PR(Y), PR(M), PR(C) and PR(K) outputted from the optical sensor SC are converted into binary values using a threshold voltage Vth to obtain binary signals BS(Y), BS(M), BS(C) and BS(K) as shown in the row “AFTER BINARY CONVERSION” of FIG. 24. The displacement of the formation position of the registration mark RM of the respective colors are calculated from a time interval T1, T2, T3 between a rising edge of the binary signal BS(Y) of yellow (Y) as a reference and a rising edge of the binary signals BS(M), BS(C) and BS(K) of magenta (M), cyan (C) and black (K). In other words, if this is described with respect to magenta (M), when
Dm: displacement of the registration mark RM(M) relative to the registration mark RM(Y),
S81: conveying velocity of the surface of the transfer belt,
T1: actual measurement value of the time interval
T1rf: time interval in the absence of displacement with respect to magenta,
   the displacement Dm of magenta (M) is calculated by the following equation.

Dm=S81×(T1−T1rf)

Such a calculation is performed also for cyan (C) and black (K) to calculate displacements (color misregistration information) with respect to the respective toner colors. The color misregistration information thus calculated is outputted to the emission timing calculator 56, which then calculates optimal emission timings based on the color misregistration information. The light emission of the line head 29 is controlled based on the thus calculated emission timings to control the transfer positions of the toner images for color misregistration correction.

As described above, in this color misregistration correction operation, the registration marks RM are formed as the test images TM and the operation of detecting the registration marks RM is performed similar to the above test image detection operation. Accordingly, the registration marks RM can be properly detected by reflecting the positional variation of N group latent images GL consecutive in the main scanning direction MD on the detection result. As a result, the color misregistration information can be obtained with high accuracy. A color image forming operation is performed while the light emissions of the line heads 29 are controlled based on the color misregistration information thus obtained with high accuracy. Therefore, satisfactory color image formation can be realized.

Here, the case of applying the first example of the test image detection operation to the color misregistration correction operation was described. However, it is also possible to properly detect the registration marks RM by applying the above second or third example of the test image detection operation to the color misregistration correction operation to reflect the positional variation of N group latent images GL consecutive in the main scanning direction MD on the detection result in the color misregistration correction operation. As a result, the color misregistration information can be obtained with high accuracy, and the light emissions of the line heads 29 are controlled based on the color misregistration information thus obtained with high accuracy, wherefore satisfactory color image formation can be realized.

VI-2. Density Correction Operation

By performing the test image detection operation as described above, the test image TM can be properly detected by reflecting the positional variation of N group latent images GL consecutive in the main scanning direction MD on the detection result. Thus, by applying the above test image detection operation to a density correction operation, such a density correction operation can be satisfactorily performed. Accordingly, a case of applying the above test image detection operation to the density correction operation will be described below. Particularly, a case of applying the first example of the test image detection operation to the density correction operation will be described below

In the density correction operation, patch marks PM of the respective toner colors are formed as the test images TM. Specifically, the image forming stations Y, M, C and K form test latent images on the surfaces of the photosensitive drums 21 belonging thereto and develop these test latent images in the respective toner colors to form patch marks PM(Y), PM(M), PM(C) and PM(K) as the test images. These patch marks PM are transferred to the surface of the transfer belt 81 while being arranged in the conveying direction D81. The patch marks PM thus formed on the transfer belt 81 are conveyed in the conveying direction D81 to be detected by the optical sensor SC.

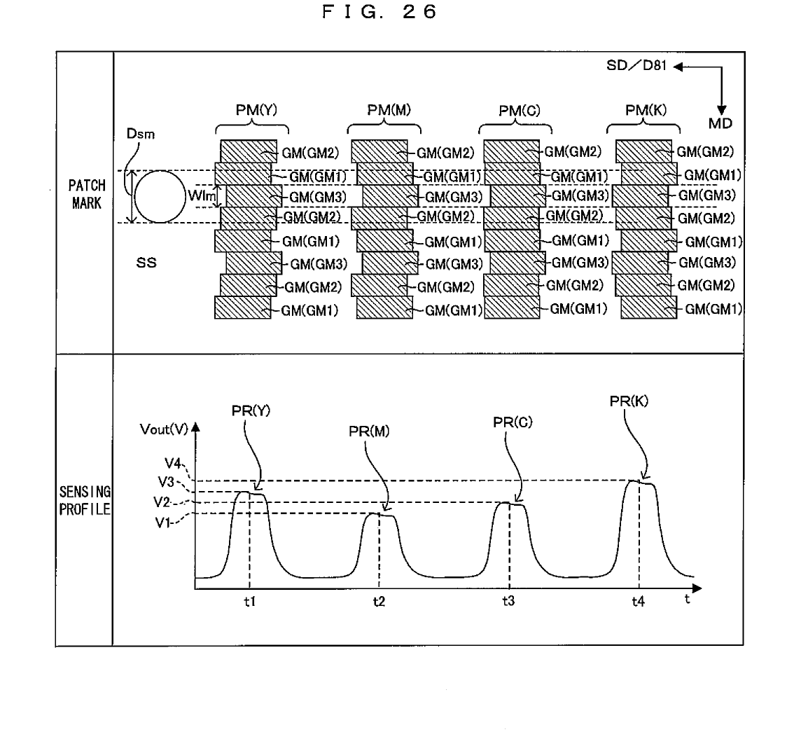

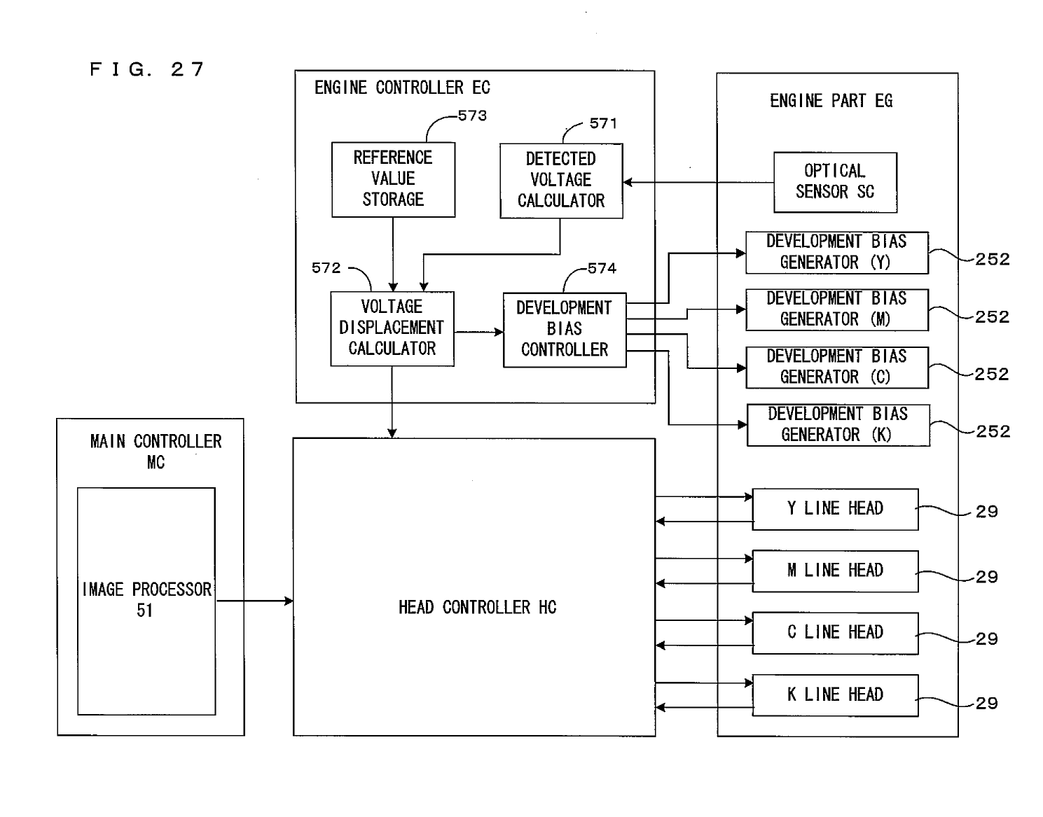

FIG. 26 is a diagram showing a process performed to the detection result of the optical sensor, and FIG. 27 is a diagram showing the electrical construction for performing the process to the detection result of the optical sensor. As described above, the patch marks PM of the respective colors are formed side by side in the conveying direction D81 and conveyed in the conveying direction D81 to pass the sensor spot SS. In this way, the patch marks PM of the respective colors are detected by the optical sensor SC. This operation of detecting the patch marks PM is performed similar to the test image detection operation described in the above “V-1. First Example of Test Image Detection Operation”.

The row “SENSING PROFILE” of FIG. 26 shows the detection result of the optical sensor SC. When the patch marks PM(Y), PM(M), PM(C) and PM(K) pass the sensor spot SS, the optical sensor SC outputs detected waveforms PR(Y), PR(M), PR(C) and PR(K) corresponding to the respective patch marks to the engine controller EC. The engine controller EC includes a detected voltage calculator 571, a voltage displacement calculator 572, a reference value storage 573 and a development bias controller 574. The detected waveforms PR(Y), PR(M), PR(C) and PR(K) are inputted as voltage signals to the detected voltage calculators 571.

In the detected voltage calculator 571, peak voltages V1 to V4 of the detected waveforms R(Y), PR(M), PR(C) and PR(K) outputted from the optical sensor SC are obtained and inputted to the voltage displacement calculator 572. The voltage displacement calculator 572 compares the respective peak voltages V1 to V4 with a reference voltage stored in the reference value storage 573 to obtain density information on the density displacement for the respective colors. If the density displacement is judged from such density information, the density correction operation is so performed that the peak voltages and the reference voltage substantially coincide. Specifically, the head controller HC corrects the exposure timings of the line heads 29 based on the density information. Further, based on the density information, the development bias controller 574 corrects a development bias value of a development bias generator 252. An image forming operation is performed based on the thus corrected image density.

As described above, in this density correction operation, the patch marks PM are formed as the test images TM and the operation of detecting the patch marks PM is performed similar to the above test image detection operation. Accordingly, the patch marks PM can be properly detected by reflecting the positional variation of N group latent images GL consecutive in the main scanning direction MD on the detection result. As a result, the density information can be obtained with high accuracy. An image forming operation is performed at an image density corrected based on the density information thus obtained with high accuracy. Therefore, satisfactory image formation can be realized.

Here, the case of applying the first example of the test image detection operation to the density correction operation was described. However, it is also possible to properly detect the patch marks PM by applying the above second or third example of the test image detection operation to the density correction operation to reflect the positional variation of N group latent images GL consecutive in the main scanning direction MD on the detection result in the density correction operation. As a result, the density information can be obtained with high accuracy, and an image forming operation is performed at an image density corrected based on the density information thus obtained with high accuracy, wherefore satisfactory image formation can be realized.

V-3. Variation Correction Operation

By performing the test image detection operation as described above, the test image TM can be properly detected by reflecting the positional variation of N group latent images GL consecutive in the main scanning direction MD on the detection result on the test image TM. In other words, the detection result on the test image TM reflects the positional variation of N group latent images GL consecutive in the main scanning direction MD. In a variation correction operation described below, the positional variation of the group latent images GL is corrected using such a detection result. Particularly, a case of applying the first example of the test image detection operation to the variation correction operation will be described below.

In the variation correction operation, variation detection marks DM are formed as the test images TM (detection mark forming process). Specifically, test latent images TLI are formed on the surfaces of the photosensitive drums 21 and developed to form variation detection marks DM. After being transferred to the surface of the transfer belt 81 and conveyed in the conveying direction D81, these variation detection marks DM are detected by the optical sensor SC (detection mark detecting process). This operation of detecting the variation detection marks DM is performed similar to the test image detection operation described in the above “V-1. First Example of Test Image Detection Operation”.

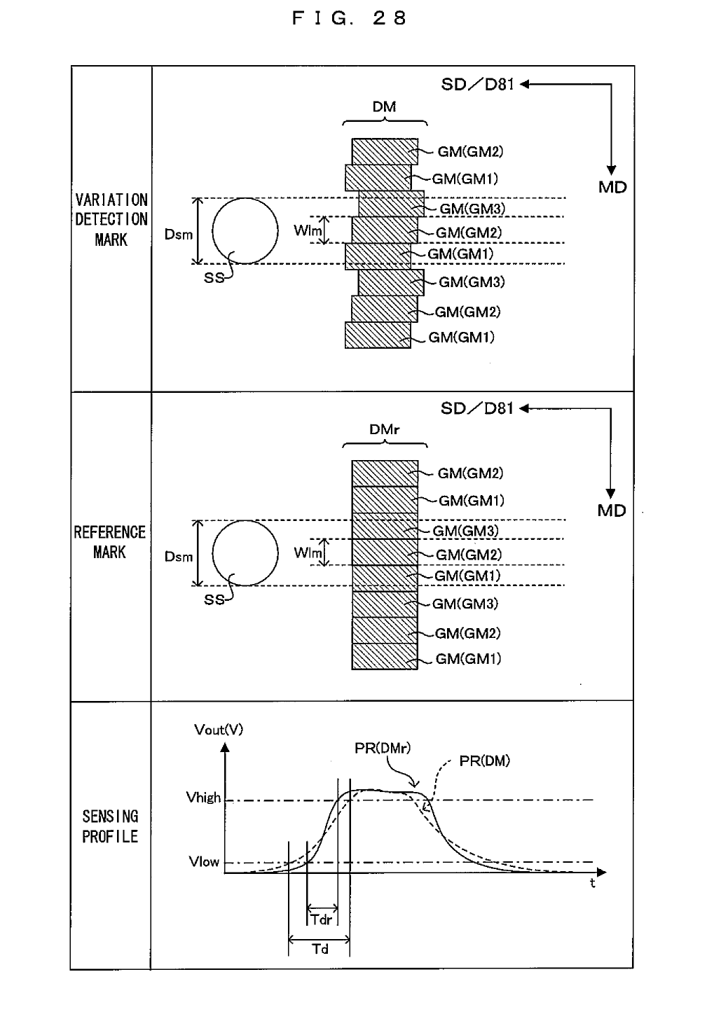

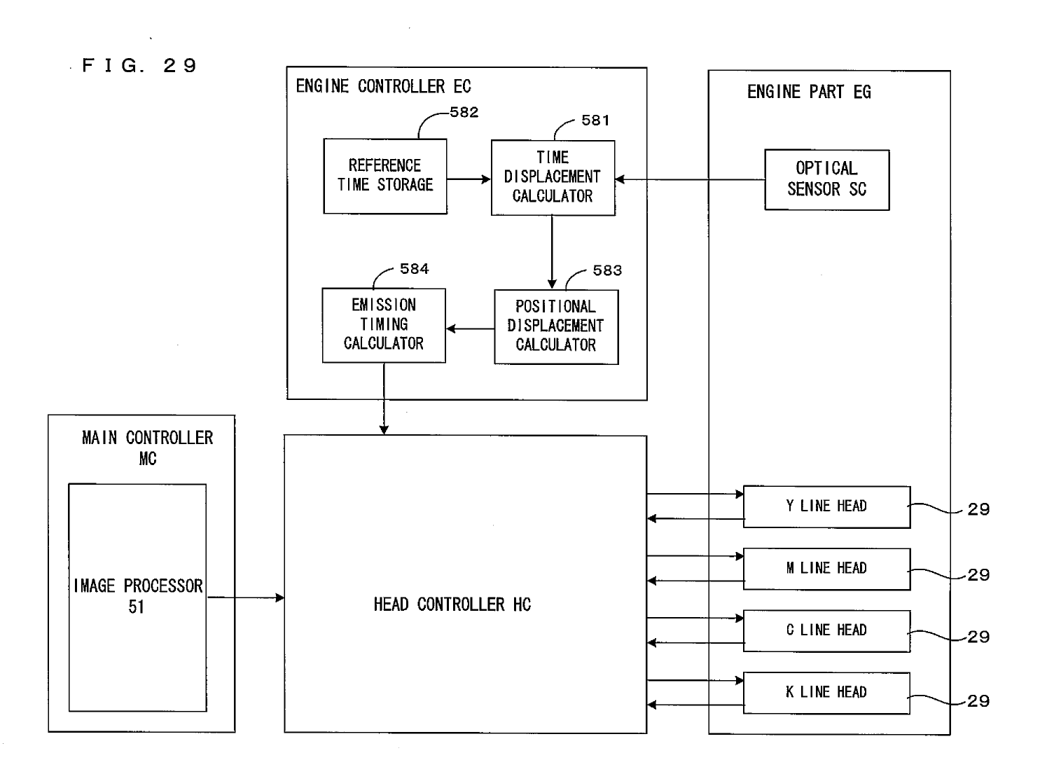

FIG. 28 is a diagram showing a process performed to the detection result of the optical sensor, and FIG. 29 is a diagram showing the electrical construction for performing the process to the detection result of the optical sensor. The row “VARIATION DETECTION MARK” of FIG. 28 shows an actually formed variation detection mark DM. The row “REFERENCE MARK” of FIG. 28 shows an ideal mark free from the positional variation of group toner images GM in the sub scanning direction SD, i.e. a reference mark DMr. In the row “SENSING PROFILE” of FIG. 28, a solid-line waveform is a reference waveform PR(DMr) corresponding to a detected waveform when the reference mark DMr was detected by the sensor spot SS and a broken-line waveform is a detected waveform PR(DM) of the variation detection mark DM by the sensor spot SS.

The optical sensor SC outputs the detected waveform PR(DM) of the variation detection mark DM to the engine controller EC. The engine controller EC includes a time displacement calculator 581, a reference time storage 582, a positional displacement calculator 583 and an emission timing calculator 584. This detected waveform PR(DM) is inputted to the time displacement calculator 581. The time displacement calculator 581 calculates a time interval Td which elapses until the rise of the detected waveform PR(DM) passes an upper threshold voltage Vhig after passing a lower threshold voltage Vlow. Then, the time displacement calculator 581 calculates a difference ΔT=Td−Tdr between this time interval Td and a reference time interval Tdr stored in the reference time storage 582. This reference time interval Tdr is a time interval which elapses until the rise of the reference waveform PR(DMr) passes the upper threshold voltage Vhig after passing the lower threshold voltage Vlow and is stored in the reference time storage 582.

The time displacement calculator 581 calculates a positional variation ΔDgm of the group toner image GM from this difference ΔT and a circumferential speed S21 of the photosensitive drum 21 and outputs this positional variation ΔDgm to the emission timing calculator 584. The emission timing calculator 584 calculates an emission timing of the line head 29 based on the positional variation ΔDgm (timing calculating process). Specifically, this emission timing is so calculated as to decrease the positional variation ΔDgm. The head controller HC controls the light emission of the line head 29 based on the thus calculated emission timing (emission controlling process). The detection mark forming process, the detection mark detecting process, the timing calculating process and the emission controlling process are repeatedly performed until the positional variation ΔDgm falls to or below a specified value. In this way, the positional variation ΔDgm is suppressed to correct the positional variation of the group latent images GL. An image forming operation is performed with the positional variation corrected in this way.

As described above, in this variation correction operation, the variation detection mark DM is formed as the test image TM and the operation of detecting the variation detection mark DM is performed similar to the above test image detection operation. Accordingly, it is possible to reflect the positional variation of N group latent images GL consecutive in the main scanning direction MD on the detection result of the variation detection mark DM. Using such a detection result, the positional variation of the group latent images GL is corrected and an image forming operation is performed with the positional variation corrected. Therefore, satisfactory image formation is realized.

Here, the case of applying the first example of the test image detection operation to the variation correction operation was described. However, it is also possible to properly detect the variation detection marks DM by applying the above second or third example of the test image detection operation to the variation correction operation to reflect the positional variation of N group latent images GL consecutive in the main scanning direction MD on the detection result in the variation correction operation. Using such a detection result, the positional variation of the group latent images GL is corrected and an image forming operation is performed with the positional variation corrected, wherefore satisfactory image formation is realized.

VI-4. Color Misregistration Correction Operation in the Main Scanning Direction

In the above embodiments, the invention is applied to the color misregistration correction operation for suppressing the color misregistration in the sub scanning direction SD. However, the application of the invention is not limited to this and the invention may also be applied to a color misregistration correction operation for suppressing the color misregistration in the main scanning direction MD. This will be described below.

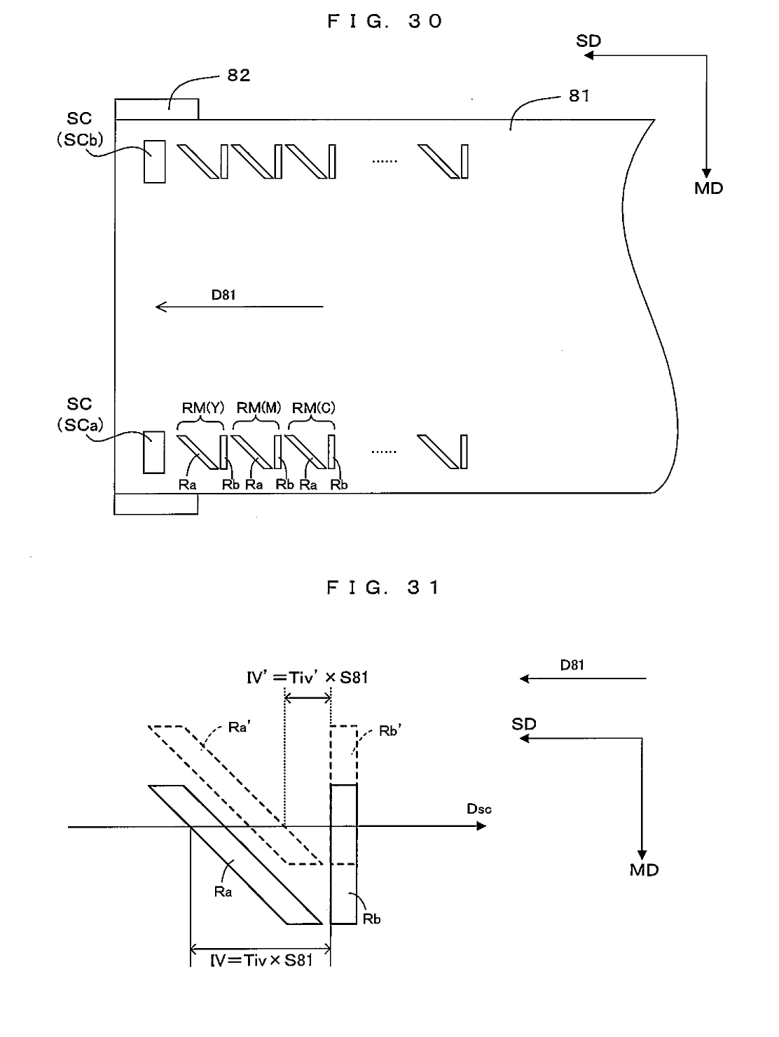

FIG. 30 is a diagram showing registration marks formed in a color misregistration correction operation in the main scanning direction. This color misregistration correction operation is similar to the above color misregistration correction operation in that registration marks RM(Y), RM(M), RM(C) and RM(K) of the respective colors Y, M, C and K are formed side by side in the sub scanning direction SD. However, the configurations of the respective registration marks RM(Y), RM(M), RM(C) and RM(K) differ between the both operations. In other words, in this color misregistration correction operation, each of the registration mark RM(Y), etc. is made up of an oblique part Ra oblique to the main scanning direction MD and a horizontal part Rb substantially parallel to the main scanning direction MD. By detecting the registration marks RM(Y), etc. made up of the oblique parts Ra and the horizontal parts Rb by optical sensors SC, displacements of the registration marks RM(Y), etc. in the main scanning direction MD can be detected.

FIG. 31 is a diagram showing the principle of the color misregistration correction operation in the main scanning direction. The registration mark Ra, Rb shown by solid line in FIG. 31 corresponds the registration mark free from displacement, and the registration mark Ra′, Rb′ shown by broken line in FIG. 31 corresponds to the registration mark having being displaced.

First of all, a detection operation of the registration mark Ra, Rb free from displacement will be described. Since the transfer belt 81 moves in the moving direction D81 as described above, the registration mark Ra, Rb also moves in the moving direction D81 as this transfer belt 81 moves. Then, the registration mark Ra, Rb passes a sensor spot (not shown in FIG. 31) of the optical sensor SC to be detected by the optical sensor SC. In other words, the sensor spot passes above the registration mark Ra, Rb in a direction of arrow Dsc shown in FIG. 31 to detect the registration mark Ra, Rb. Accordingly, the optical sensor SC detects a downstream edge of the horizontal part Rb in the moving direction D81 after first detecting a downstream edge of the oblique part Ra in the moving direction D81. At this time, an interval between the downstream edge of the oblique part Ra and the downstream edge of the horizontal part Rb on the arrow Dsc is an interval IV Accordingly, an edge detection time Tiv from the edge detection of the oblique part Ra to that of the horizontal part Rb is obtained from an equation (IV/S81). Here, S81 is a conveying speed of the transfer belt 81.

On the other hand, in an example shown in FIG. 31, the registration mark Ra′, Rb′ is displaced upward relative to the registration mark Ra, Rb. As a result, an interval IV′ between the downstream edge of the oblique part Ra′ and the downstream edge of the horizontal part Rb′ on the arrow Dsc in the registration mark Ra′, Rb′ thus displaced is shorter as compared with the case free from displacement (i.e. IV′<IV). Accordingly, an edge detection time Tiv′ (=IV′/S81) from the edge detection of the oblique part Ra′ to that of the horizontal part Rb′ is also shorter than the edge detection time Tiv in the case free from displacement (i.e. Tiv′<Tiv). If the registration mark Ra′, Rb′ is displaced downward contrary to the example shown in FIG. 31, the edge detection time Tiv′ becomes longer than the edge detection time Tiv (i.e. Tiv′>Tiv). As described above, if the registration marks RM(Y), etc. are displaced, the edge detection times Tiv from the downstream edge detections of the oblique parts Ra to those of the horizontal parts Rb vary. Therefore, in the color misregistration correction operation in the main scanning direction, displacements in the main scanning direction MD among the respective colors are calculated from the edge detection times Tiv.

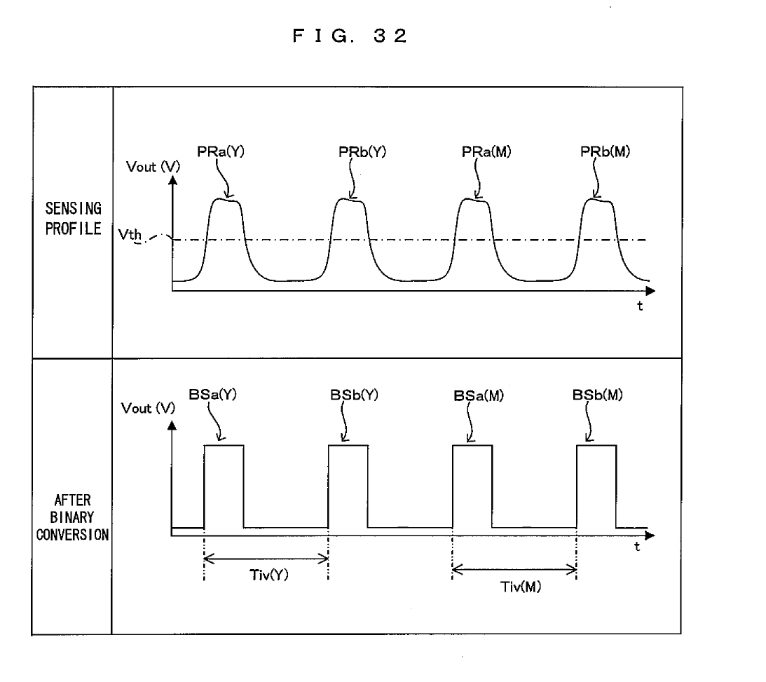

FIG. 32 is graphs showing the color misregistration correction operation in the main scanning direction. FIG. 32 shows a case where a displacement in the main scanning direction MD between yellow (Y) and magenta (M) is calculated. In the row “SENSING PROFILE” of FIG. 32 are shown signals outputted from the optical sensor SC upon detecting the registration marks RM(Y), etc. In the row “AFTER BINARY CONVERSION” of FIG. 32 are shown signals obtained by converting the signals shown in the sensing profile into binary values using a threshold voltage Vth. As shown in the sensing profile, the oblique part Ra of the registration mark RM(Y) of yellow (Y) is first detected to obtain a profile signal PRa(Y) and then the horizontal part Rb of the registration mark RM(Y) of yellow (Y) is detected to obtain a profile signal PRb(Y). Subsequently, the oblique part Ra of the registration mark RM(M) of magenta (M) is detected to obtain a profile signal PRa(M) and then the horizontal part Rb of the registration mark RM(M) of magenta (M) is detected to obtain a profile signal PRb(M).

The respective profile signals PRa(Y), PRb(Y), PRa(M) and PRb(M) thus obtained are converted into binary values to obtain binary signals BSa(Y), BSb(Y), BSa(M) and BSb(M). The edge detection times Tiv for the respective colors are calculated from rising edge intervals of the binary signals BSa(Y), BSb(Y), BSa(M) and BSb(M). Specifically, the edge detection time Tiv(Y) of yellow (Y) is calculated from the rising edges of the binary signals BSa(Y), BSb(Y), and the edge detection time Tiv(M) of magenta (M) is calculated from the rising edges of the binary signals BSa(M), BSb(M). By multiplying a difference between the edge detection times Tiv of the respective colors (=Tiv(Y)−Tiv(M)) by the moving speed S81 of the transfer belt 81, a displacement in the main scanning direction M between the registration marks RM(Y) and RM(M) can be calculated.

The above test image detection operation can be also applied to this color misregistration correction operation in the main scanning direction. Particularly, a case of applying the first example of the test image detection operation to the color misregistration correction operation will be described below.

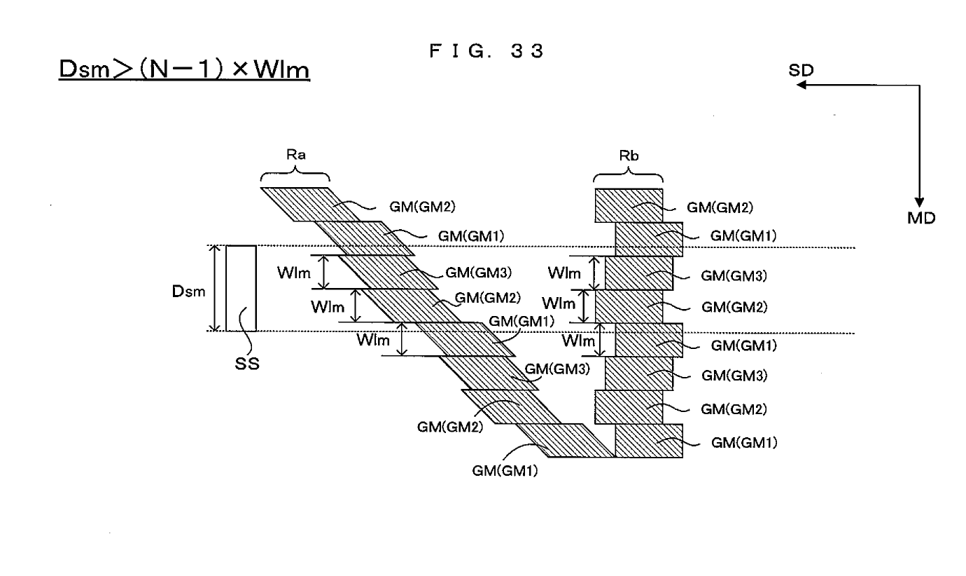

FIG. 33 is a diagram showing a relationship between the sensor spot of the optical sensor and a registration mark in the color misregistration correction operation in the main scanning direction. As shown in FIG. 33, the main-scanning spot diameter Dsm of the sensor spot SS1 is larger than the (N-1)-fold of the unit width Wlm. Accordingly, as shown by broken lines of FIG. 33, N group toner images GM (GM1 to GM3) consecutive in the main scanning direction MD can be reliably detected by the sensor spot SS. Thus, the sensor spot SS shown in FIG. 33 is preferable since being able to detect the registration mark RM by reflecting the positional variation of the N group latent images GL consecutive in the main scanning direction MD on the detection result.

VI-5. Operation for Correcting Color Misregistration Resulting from Sub Scanning Magnification

In the above embodiments, displacements among mutually different colors are calculated by detecting the registration marks RM. However, besides displacements among mutually different colors, there are cases where a displacement called “sub scanning magnification displacement” occurs for one color. Specifically, there are cases where the speed of the photosensitive drum 21 is faster or slower than a desired speed, for example, for a certain color to contract or extend an image transferred to the transfer belt 81, with the result that the image transferred to the transfer belt 81 looks as if the magnification thereof would have been deviated in the sub scanning direction SD (as if a sub scanning magnification displacement would have occurred). Such a sub scanning magnification displacement can also be calculated by detecting the registration mark RM as described next.

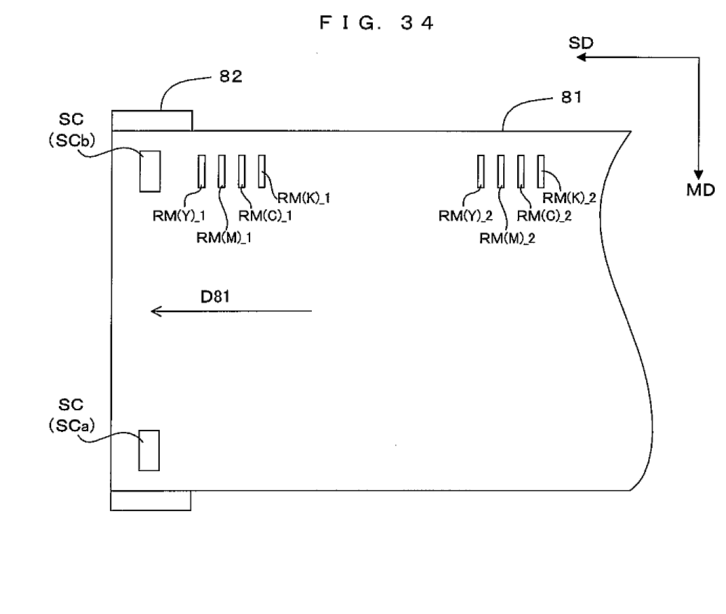

FIG. 34 is a diagram showing registration marks formed in a sub scanning magnification displacement correction operation. As shown in FIG. 34, two registration marks RM are formed for each of the colors Y, M, C and K while being spaced apart in the sub scanning direction SD. For example, for yellow (Y), the registration marks RM(Y)_1, RM(Y)_2 are formed while being spaced apart in the sub scanning direction SD. These two registration marks RM(Y)_1, RM(Y)_2 are detected by an optical sensor SC to calculate a sub scanning magnification displacement for yellow (Y).

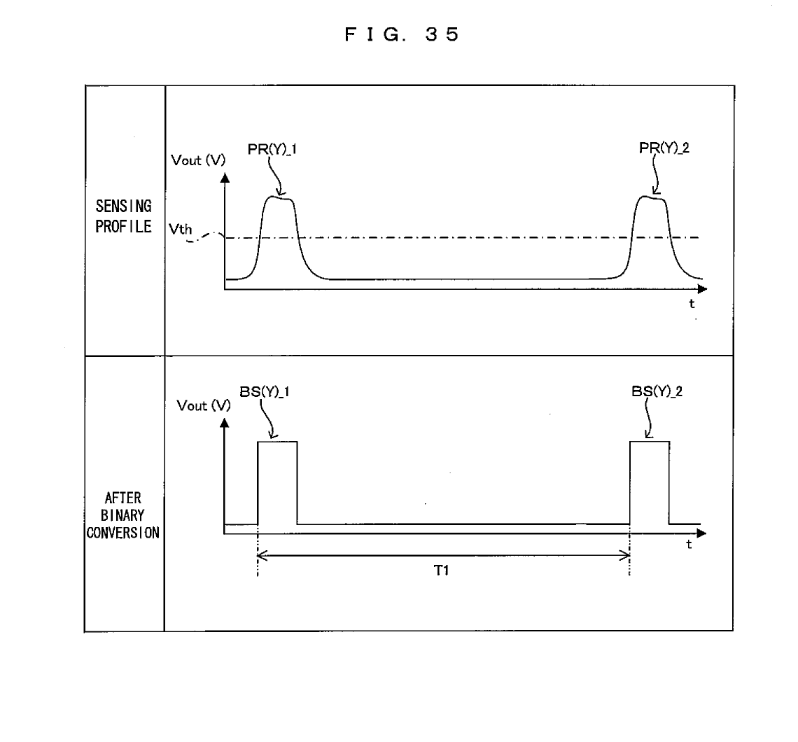

FIG. 35 is graphs showing the sub scanning magnification displacement correction operation and corresponds to a case of calculating the sub scanning magnification displacement for yellow (Y). In the row “SENSING PROFILE” of FIG. 35 are shown signals outputted by the optical sensor SC upon detecting the registration marks RM(Y)_1, RM(Y)_2. In the row “AFTER BINARY CONVERSION” of FIG. 35 are shown signals obtained by converting the signals shown in the sensing profile into binary values using a threshold voltage Vth. As shown in the sensing profile, the downstream registration mark RM(Y)_1 in the moving direction D81 of the transfer belt 81 is first detected to obtain a profile signal PR(Y)_1 and then the upstream registration mark RM(Y)_2 in the moving direction D81 is detected to obtain a profile signal PR(Y)_2.

The respective profile signals PR(Y)_1, PR(Y)_2 thus obtained are converted into binary values to obtain binary signals BSa(Y), BSb(Y). An edge detection time T1 is calculated from a rising edge interval of the binary signals BSa(Y), BSb(Y), and an interval between the registration marks PR(Y)_1, PR(Y)_2 in the sub scanning direction SD is calculated by multiplying this edge detection time T1 by the conveying speed S81 of the transfer belt 81. Then, by calculating how far the thus calculated interval between the registration marks PR(Y)_1, PR(Y)_2 is deviated from a desired value, the sub scanning magnification displacement can be calculated for yellow (Y). Sub scanning magnification displacements can be similarly calculated for the colors other than yellow (Y). By controlling, for example, the emission timings of the light emitting elements 2951 based on the thus calculated sub scanning magnification displacements, the length of the image to be transferred to the transfer belt 81 in the sub scanning direction SD can be set to a suitable length.

By applying the above test image detection operation according to the invention also to the operation for correcting color misregistration resulting from a sub scanning magnification, the positional variation of the N group latent images GL consecutive in the main scanning direction MD can be reflected on the detection result on the registration mark RM. By performing the color misregistration correction operation using such a detection result, color misregistration resulting from the sub scanning magnification is properly corrected to realize satisfactory image formation.

VII. Modification of Optical Sensor

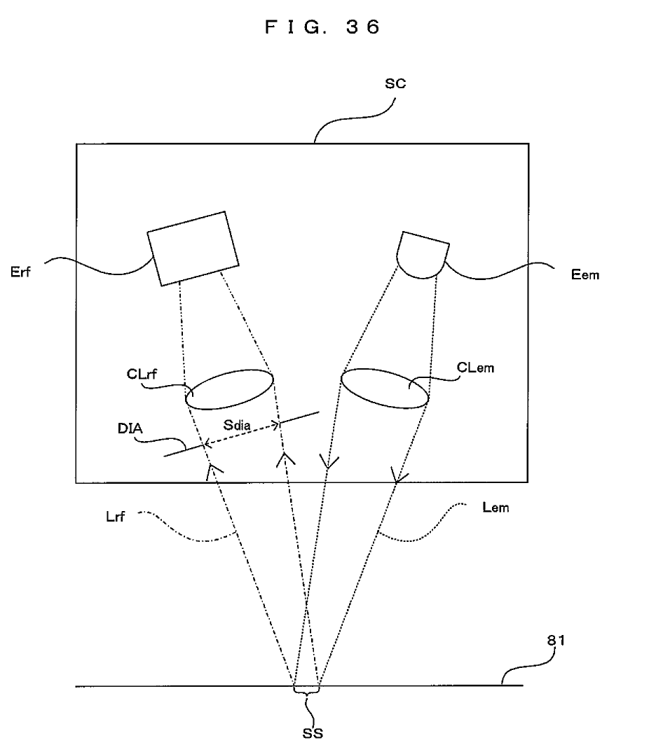

FIG. 36 is a diagram showing a modification of the optical sensor. The optical sensor SC according to the modification is similar to the optical sensor SC shown in FIG. 17 except in including an aperture diaphragm DIA. This aperture diaphragm DIA is provided between the sensor spot SS and the light emitter Erf. Accordingly, only light having passed through the aperture diaphragm DIA out of light reflected by the transfer belt 81 can reach the light emitter Erf. Further, an area Sdia of the opening of the aperture diaphragm DIA is variable, and the quantity of the light reaching the light emitter Erf can be controlled by adjusting the opening area Sida. In other words, in this optical sensor, the size and shape of the sensor spot SS can be adjusted by changing the opening area Sdia. Such a function of adjusting the sensor spot SS can also be realized by providing the aperture diaphragm DIA between the light emitter Eem and the sensor spot SS. In other words, in this case, only light having passed through the aperture diaphragm DIA out of light emitted from the light emitter Eem can be reflected by the transfer belt 81 and reach the light emitter Erf. Accordingly, the quantity of the light reaching the light receiver Erf can be controlled and the size and shape of the sensor spot SS can be adjusted by changing the opening area Sdia.

As described above, in FIG. 36, the diaphragm DIA is provided and the light quantity used for the detection of a detection image can be restricted by the diaphragm. As a result, the occurrence of a problem that the detection result is disturbed, for example, by stray lights can be suppressed. Since the diaphragm is formed such that the light quantity passing through this diaphragm is variable, the light quantity used for the detection of a detection image can be adjusted if necessary. In other words, the size and shape of the sensor spot SS can be adjusted. Therefore, the diameter of the sensor spot SS can be easily set as in the above embodiments.

As described above, in the above embodiment, the main scanning direction MD corresponds to a “first direction” of the invention, and the sub scanning direction SD to a “second direction” of the invention. Further, in the above embodiment, the respective image forming stations Y, M, C and K correspond to “image forming assemblies” of the invention; the photosensitive drum 21 to a “latent image bearing member” of the invention; the light emitting element group column 295C to a “group column”; the optical sensor SC to a “detector” of the invention; and the sensor spot SS to a “detection area” of the invention. Further, the line head 29 corresponds to an “exposure head” of the invention; the lens LS corresponds to an “imaging optical system” of the invention; the light emitting element group 295 to “a plurality of light emitting elements” of the invention; the width of the test image TM in the main scanning direction MD to “a width L2 in the first direction of an image detected by the detector”; and the width which is the (N-1)-fold of the unit width Wlm in the main scanning direction MD to a “width L3 in the first direction of latent images formed on the latent image bearing member by two or more imaging optical systems”. Further, the above operation of forming the test latent images TLI is performed by the controls of the main controller MC and the head controller HC, and the main controller MC and the head controller HC function as a “controller” of the invention.

In the invention (image forming apparatus, image forming method) thus constructed, the test latent image and the detection area are wider than the (N-1)-fold of the width of the latent image formed by all the light emitting elements belonging to one light emitting element group. Accordingly, the test image can be properly detected by reflecting the variation of the above N latent images on the detection result on the test image.

In the first direction, the test latent image may be formed by latent images formed by N or more light emitting element groups and adjacent in the first direction. Each of at least N light emitting element groups capable of exposure in the first direction may form a latent image by all the light emitting elements belonging thereto. By such a construction, the test image can be more properly detected.

At this time, the test latent image may be formed by N light emitting element groups. In this case, the widths in the first direction of the N latent images constituting the test latent image may be equal to each other. As a result, the influence of the respective latent images on the detection result of the detector can be made substantially equal among the N latent images. Therefore, the test image can be more properly detected.

In the first direction, the detection area may be wider than the N-fold of the width of the latent image formed by all the light emitting elements belonging to one light emitting element group. By such a construction, the test image can be more properly detected.

Image formation information relating to image formation may be obtained based on the detection result of the detector. By such a construction, the image formation information can be obtained based on the proper detection result on the test image, with the result that the image formation information can be obtained with high accuracy.

An image forming operation may be controlled based on the image formation information. By such a construction, satisfactory image formation can be performed.

VIII. Miscellaneous

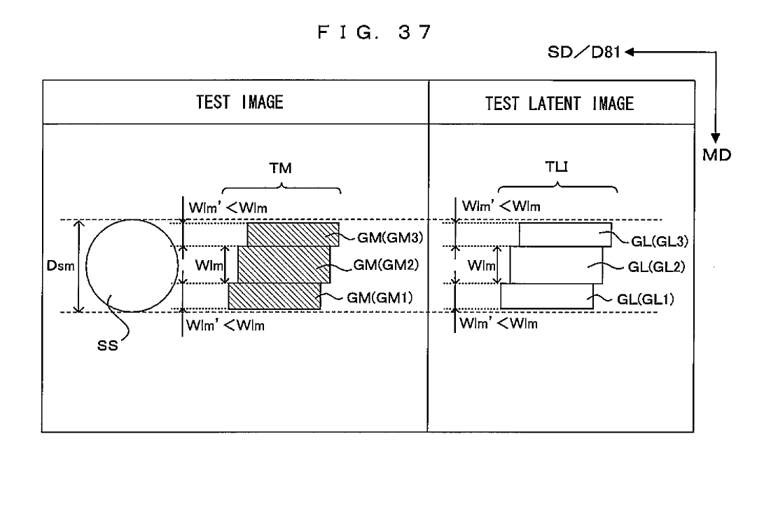

The invention is not limited to the above embodiment and various changes other than the above can be made without departing from the gist thereof. For example, in “V-1. First Example of Test Image Detection operation”, the test latent image TLI has the width in the main scanning direction MD equal to or larger than the N-fold of the unit width Wlm. However, the width of the test latent image TLI in the main scanning direction MD is not limited to this and is sufficient to be larger than the (N-1)-fold of the unit width Wlm. Accordingly, the test latent image TLI may be configured as shown in FIG. 37. FIG. 37 is a diagram showing another configuration of the test latent image and corresponds to a case where N=3. As shown in FIG. 37, the test latent image TLI is made up of N group latent images GL1 to GL3 consecutive in the main scanning direction MD. In the main scanning direction MD, the width of the group latent image GL2 is equal to the unit width Wlm, whereas those Wlm′ of the group latent images GL1, GL3 are smaller than the unit width Wlm. This results from the fact that each of the light emitting element groups 295 having formed the group latent images GL1, GL3 used only some of the eight light emitting elements 2951 belonging thereto for the formation of the group latent image GL. As a result, in the main scanning direction MD, the test latent image TLI is wider than the (N-1)-fold of the unit width Wlm, but narrower than the N-fold of the unit width Wlm.

In “V-2. Second Example of Test Image Detection operation”, the test latent image TLI is made up of the group latent images GL formed by eight light emitting element groups 295 and consecutive in the main scanning direction MD. All of these eight light emitting element groups 295 form the group latent images GL by all the light emitting elements 2951 belonging thereto. However, it is not necessary to form all the group latent images GL constituting the test latent image TLI by all the light emitting element groups 295 belonging to the light emitting element groups 295. For example, only N light emitting element groups 295 may form the group latent images GL by all the light emitting elements 2951 belonging thereto.

Although all the light emitting elements 2951 of each of the N light emitting element groups 295 emit lights to form the group latent image GL in the above embodiment, the group latent image may be formed by driving only some of the light emitting elements 2951 belonging to each light emitting element group 295 to emit lights. Further, in the above embodiment, the light emitting element group 295 includes a plurality of light emitting element rows 2951R. Accordingly, the respective group latent images GL constituting the test latent image TLI may be formed, for example, by causing only one of the plurality of light emitting element rows 295IR to emit lights. In other words, the respective group latent images GL may be formed by causing only the light emitting element column 2951R_1 of FIG. 8 to emit lights. A detection image obtained by developing the thus formed test latent image TLI may be detected. In short, it is sufficient that the detection image such as a registration mark has a width wider than the unit width Wlm in the main scanning direction MD.

The above embodiments correspond to the case where one light emitting element group column 295C is made up of three light emitting element groups 295, i.e. the case where “N” of the invention is 3. However, the number of the light emitting element groups 295 constituting one light emitting element group column 295C is not limited to 3 and may be any integer equal to or greater than 2 (i.e. “N” may be any integer equal to or greater than 2)

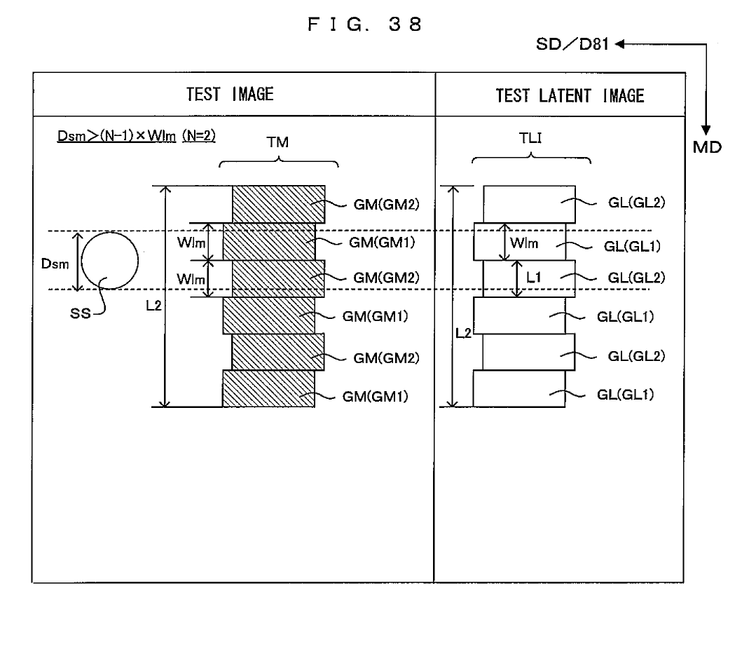

For example, as shown in FIG. 38, in the case of N=2, the width L2 in the main scanning direction MD of the test image detected by the optical sensor SC is sufficient to be larger than the (N-1)-fold of the unit width Wlm, i.e. the unit width Wlm. Here, FIG. 38 is a diagram showing a test image detection operation in the case of N=2. In other words, the test image may be formed such that the width L2 in the main scanning direction MD of the test image detected by the optical sensor SC and a width L1 (=unit width Wlm) in the main scanning direction MD of a latent image formed on the latent image bearing member by one imaging optical system satisfy a relationship defined by the following equation:

L2>L1.

By making the main-scanning spot diameter Dsm of the sensor spot SS larger than the (N-1) of the unit width Wlm, i.e. the unit width Wlm, the registration marks RM can be properly detected by reflecting the positional variation of N group latent images GL consecutive in the main scanning direction MD on the detection result.

In the above embodiments, the light emitting element group 295 includes eight light emitting elements 2951. However, the number of the light emitting elements 2951 constituting the light emitting element group 295 is not limited to this and may be 2 or greater.

In the above embodiments, organic EL devices are used as the light emitting elements 2951. However, devices usable as the light emitting elements 2951 are not limited to organic EL devices and LEDs (Light Emitting diodes) may also be used as the light emitting elements 2951.

In the case of using organic EL devices, particularly bottom-emission type EL devices as the light emitting elements 2951, emitted light quantities tend to decrease and an image to be formed is easily influenced by stray lights and the like. Accordingly, in such a case, the light shielding member 297 described with reference to FIG. 4 and other figures is preferably provided to suppress the influence of stray lights.

In the above embodiments, the invention is applied to the so-called tandem image forming apparatus. However, image forming apparatuses to which the invention is applicable are not limited to tandem image forming apparatuses. For example, JP-A-2002-132007 discloses a so-called rotary image forming apparatus including one photosensitive member and one exposure unit and adapted to successively form latent images corresponding to the respective colors on a photosensitive member surface using the exposure unit. The invention is also applicable to such a rotary image forming apparatus.

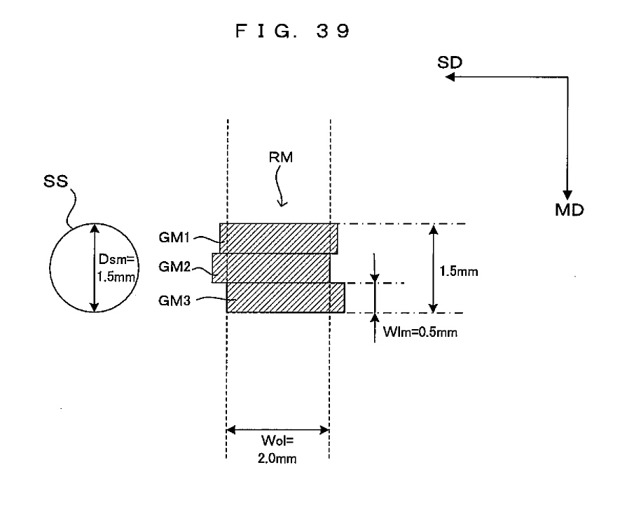

Although specific sizes of the sensor spot SS and the registration mark RM are not particularly described in the above embodiments, these sizes may be set as follows. FIG. 39 is a diagram showing exemplary sizes of a sensor spot and a registration mark. As shown in FIG. 39, the registration mark RM is made up of three group toner images GM1, GM2, GM3 and the respective group toner images GM1, GM2, GM3 are formed to have a unit width Wlm (=0.5 mm) in the main scanning direction MD. Accordingly, the registration mark RM has a width of 1.5 mm in the main scanning direction MD. These group toner images GM1, GM2, GM3 overlap with an overlapping width Wol=2.0 mm in the sub scanning direction SD. On the other hand, the sensor spot SS has a circular shape and a main-scanning spot diameter Dsm thereof is 1.5 mm. Since the sensor spot SS is formed wider than the unit width Wlm in this way, the detection result of an optical sensor SC can be made proper. The sizes of FIG. 39 are merely examples and it goes without saying that the sizes of the sensor spot and the registration mark can be changed if necessary.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. An image forming apparatus, comprising:
an exposure head including an imaging optical system arranged in a first direction and a light emitting element that emits light to be imaged by the imaging optical system;
a latent image bearing member that moves in a second direction and carries a latent image formed by the exposure head;
a developing unit that develops the latent image formed by the exposure head;
a detector that detects the image developed by the developing unit; and
a controller that controls image formation such that a width L1 in the first direction of a latent image formed on the latent image bearing member by one imaging optical system and a width L2 in the first direction of the image detected by the detector has a relationship of L2>L1.

2. The image forming apparatus according to claim 1, comprising a transfer medium, to which the image is to be transferred, wherein the detector detects the image transferred to the transfer medium.

3. The image forming apparatus according to claim 2, wherein the exposure head, the latent image bearing member and the developing unit are arranged around the transfer medium in correspondence with a different color.

4. The image forming apparatus according to claim 3, wherein the controller obtains information on a transferred position of the image from the detection result of the detector.

5. The image forming apparatus according to claim 4, wherein the controller controls the image position of a different color based on the information.

6. The image forming apparatus according to claim 2, wherein the detector has a detection area on the transfer medium, a width of the detection area being wider than the width L1 in the first direction.

7. The image forming apparatus according to claim 6, wherein the detector includes a light emitter that emits light to the detection area and a light receiver that receives the reflected light from the detection area, and detects the image based on the light received by the light receiver.

8. The image forming apparatus according to claim 7, comprising a diaphragm disposed between the light emitter and the detection area or between the detection area and the light receiver.

9. The image forming apparatus according to claim 1, wherein the detector detects the density of the image.

10. The image forming apparatus according to claim 1, wherein the latent image bearing member is a photosensitive drum rotatable about a central axis of rotation.

11. The image forming apparatus according to claim 1, wherein the exposure head includes a light shielding member arranged between the light emitting element and the imaging optical system and formed with light guide hole.

12. The image forming apparatus according to claim 1, wherein the light emitting element is an organic EL device.

13. The image forming apparatus according to claim 12, wherein the light emitting element is of the bottom-emission type.

14. An image forming apparatus, comprising:
an exposure head including an imaging optical system arranged in a first direction and a light emitting element that emits light to be imaged by the imaging optical system;
a latent image bearing member that moves in a second direction and carries a latent image formed by the exposure head;
a developing unit that develops the latent image formed by the exposure head;
a detector that detects the image developed by the developing unit; and
a controller that controls image formation such that a width L3 in the first direction of a latent image formed on the latent image bearing member by two or more imaging optical systems and a width L2 in the first direction of the image detected by the detector has a relationship of L2>L3.

15. An image forming method, comprising:
forming a latent image on a latent image bearing member by an exposure head including an imaging optical system arranged in a first direction and a light emitting element for emitting light to be imaged by the imaging optical system, the latent image bearing member moving in a second direction;
developing the latent image formed by the exposure head; and
detecting the image formed such that a width L1 in the first direction of a latent image formed on the latent image bearing member by one imaging optical system and a width L2 in the first direction of the image detected by the detector has a relationship of L2>L1.
